(19) United States
(12) Patent Application Publication
(10) Pub. No.: US 2016/0259115 A1
(43) Pub. Date: Sep. 8, 2016

(54) PRISM SHEET, SURFACE LIGHT SOURCE DEVICE, IMAGE SOURCE UNIT, AND LIQUID CRYSTAL DISPLAY DEVICE

(71) Applicant: DAI NIPPON PRINTING CO., LTD., Tokyo-to (JP)

(72) Inventors: Keiko KITANO, Tokyo-to (JP); Daijiro KODAMA, Tokyo-to (JP)

(21) Appl. No.: 15/025,096

(22) PCT Filed: Sep. 26, 2014
(86) PCT No.: PCT/JP2014/075657

§ 371 Date: Mar. 25, 2016

(30) Foreign Application Priority Data
Sep. 26, 2013 (JP) 2013-200515
Sep. 26, 2013 (JP) 2013-200516

(51) Int. Cl. F21V 8/00; G02B 5/02; G02B 5/04; G02F 1/1333

(52) U.S. Cl. CPC G02B 6/0053; G02F 1/133308; G02B 5/0231; G02B 5/045

(57) ABSTRACT

Provided is a prism sheet which inhibits the occurrence of scintillations, having less light loss. The prism sheet includes a body portion formed in a sheet, having a light transmitting property, a unit prism portion arranged on one face side of the body portion, having a plurality of unit prisms each having a convex and arrayed in a direction along a sheet face, and a light diffusing layer arranged on the other face side of the body portion, wherein P and Ra have a predetermined relationship wherein P (μm) is a pitch of the plurality of unit prisms and Ra (μm) is a surface roughness of the light diffusing layer.

### TECHNICAL FIELD

The present invention relates to prism sheets included in surface light source devices which function as lighting of display devices, surface light source devices having the prism sheets, image source units, and liquid crystal display devices.

### BACKGROUND ART

Surface light source devices (back light) are used in liquid crystal display devices such as liquid crystal televisions, to provide images to observers. A surface light source device is arranged on the back face side of a liquid crystal panel which includes image information, and used as lighting to the liquid crystal panel.

As the surface light source device like this, for example Patent Literature 1 discloses a technique. According to this, a surface light source device is formed including a light source, a light guide plate (light guide body) which guides lights emitted from the light source to a light guiding direction and broaden the lights in a planar shape to emit, and a prism sheet (lens sheet) which deflects the lights in a predetermined direction (changes the traveling directions of the lights in a predetermined direction).

In the surface light source device, the prism sheet is arranged between the light output face side of the light guide plate and the liquid crystal panel, and it changes directions of the lights from the light guide plate so that the lights can efficiently pass through the liquid crystal panel. For this purpose, the prism sheet has a plurality of unit prisms arrayed on the light guide plate side, that is, on the light input side. On the other hand, on the light output face side of the prism sheet where the unit prisms are not arranged, a layer containing a light diffusing agent is formed.

Patent Literature 1 describes maintenance of a concealing property and widening of the view angle while inhibiting scintillations, by further satisfying predetermined conditions.

### CITATION LIST

### Patent Literature

### Patent Literature 1: JP 2010-224251 A

### SUMMARY OF INVENTION

### Technical Problem

However, as described in Patent Literature 1, studied in the conventional surface light source devices like this were only about solutions of giving a high haze to a layer having a diffusing property to prevent scintillations (description of claim 1 of Patent Literature 1). An optical member having a high haze like this leads to light losses, due to diffusions of lights in unnecessary directions, and improvements are needed in view of efficiently utilizing the lights from the surface light source device.

Here, the scintillation is defined as follows. That is, the scintillation is a phenomenon that, when the screen of a display device is turned on, unevenness of brightness formed in fine particle shapes appears on the screen, and the unevenness of brightness in particle shapes seems to change its positions when the view angles are changed.

Considering the above, an object of the present invention is to provide a prism sheet which inhibits the occurrence of scintillations, having less light loss. Further provided are a surface light source unit having the prism sheet, an image source unit, and a liquid crystal display device.

### Solution to Problem

Hereinafter the present invention will be described.

The present invention is a prism sheet which changes directions of incident lights to emit the incident lights, the prism sheet including: a body portion formed in a sheet, having a light transmitting property; a unit prism portion arranged on one face side of the body portion, having a plurality of unit prisms each having a convex shape and arrayed in a direction along a sheet face; and a light diffusing layer arranged on the other face side of the body portion, wherein: a vertex angle at a tip of the convex shape of each of the unit prisms is no more than 80°; and Ra≦−0.0296·P+1.9441 is satisfied wherein P (μm) is a pitch of the plurality of unit prisms, and Ra (μm) is a surface roughness of the light diffusing layer.

The present invention is also a prism sheet which changes directions of incident lights to emit the incident lights, the prism sheet including: a body portion formed in a sheet, having a light transmitting property; a unit prism portion arranged on one face side of the body portion, having a plurality of unit prisms each having a convex shape and arrayed in a direction along a sheet face; and a light diffusing layer arranged on the other face side of the body portion, wherein: one side across a tip of the convex shape is a light input face of each of the unit prisms, the other side is a reflection face, and the reflection face consists of three faces each having a different inclination angle; and Ra≦−0.0263·P+2.0537 is satisfied wherein P (μm) is a pitch of the plurality of unit prisms and no less than 10 μm, and Ra (μm) is a surface roughness of the light diffusing layer and no less than 0.035 μm.

The present invention is also a prism sheet which changes directions of incident lights to emit the incident lights, the prism sheet including: a body portion formed in a sheet, having a light transmitting property; a unit prism portion arranged on one face side of the body portion, having a plurality of unit prisms each having a convex shape and arrayed in a direction along a sheet face; and a light diffusing layer arranged on the other face side of the body portion, wherein: the unit prism is formed in a symmetrical shape and a vertex angle at a tip of the convex shape of each of the unit prisms is no more than 80°; and Ra≦−0.0208·P+2.0223 is satisfied wherein P (μm) is a pitch of the plurality of unit prisms, and Ra (μm) is a surface roughness of the light diffusing layer.

The present invention is also a surface light source device including: a light source; a light guide plate which guides lights emitted from the light source; and any one of the above-described prism sheets, arranged on a light output face side of the light guide plate.

The present invention is also an image source unit including: the above-described surface light source device; and a liquid crystal panel arranged on a light output side of the surface light source device.

The present invention is also a liquid crystal display device including: the above-described image source unit; and a housing accommodating the image source unit thereinside.

### Advantageous Effects of Invention

According to the present invention, it is possible to inhibit the occurrence of scintillations, even though the haze of the light diffusing layer is lowered in order to inhibit the decrease in brightness and inhibit light losses.

### BRIEF DESCRIPTION OF DRAWINGS

FIG. 1 is a perspective view of an exterior of a liquid crystal display device 1;

FIG. 2 is an exploded perspective view to explain an image source unit 10 according to a first embodiment;

FIG. 3 is an exploded view showing a cross section (cross section cut along in FIG. 2) of the image source unit 10;

FIG. 4 is an exploded view showing another cross section (cross section cut along IV-IV in FIG. 2) of the image source unit 10;

FIG. 5 is an enlarged view of a part of a light guide plate 21;

FIG. 6 is an enlarged view of a part of a prism sheet 30;

FIG. 7 is an enlarged view of a part of a prism sheet 130, explaining a second embodiment;

FIG. 8 is a view to explain the shape of a unit prism 132a;

FIG. 9 is an exploded view showing one cross section of an image source unit 210, explaining a third embodiment;

FIG. 10 is an enlarged view of a part of a prism sheet 230;

FIG. 11 is a view to explain the shape of one unit prism used in Example 1;

FIG. 12 is a view to explain the shape of another unit prism used in Example 1;

FIG. 13 is a graph showing the relationship between a pitch P of the unit prism and a surface roughness Ra of a light diffusing layer of Example 1;

FIG. 14 is a graph showing the relationship between a pitch P of the unit prism and a surface roughness Ra of a light diffusing layer of Example 2;

FIG. 15 is a view to explain the shape of one unit prism used in Example 3;

FIG. 16 is a view to explain the shape of another unit prism used in Example 3; and

FIG. 17 is a graph showing the relationship between a pitch P of the unit prism and a surface roughness Ra of the light diffusing layer of Example 3.

### DESCRIPTION OF EMBODIMENTS

Hereinafter the present invention will be described based on the embodiments shown in the drawings. However, the present invention is not limited to these embodiments. In each drawing shown below, sizes and shapes of members may be overdrawn for the purpose of easy understanding, and repeating symbols may be omitted for the purpose of easy reading.

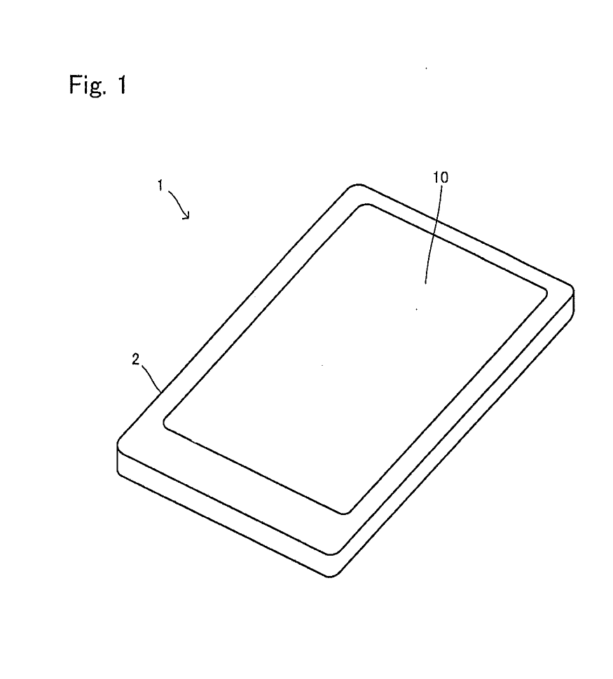

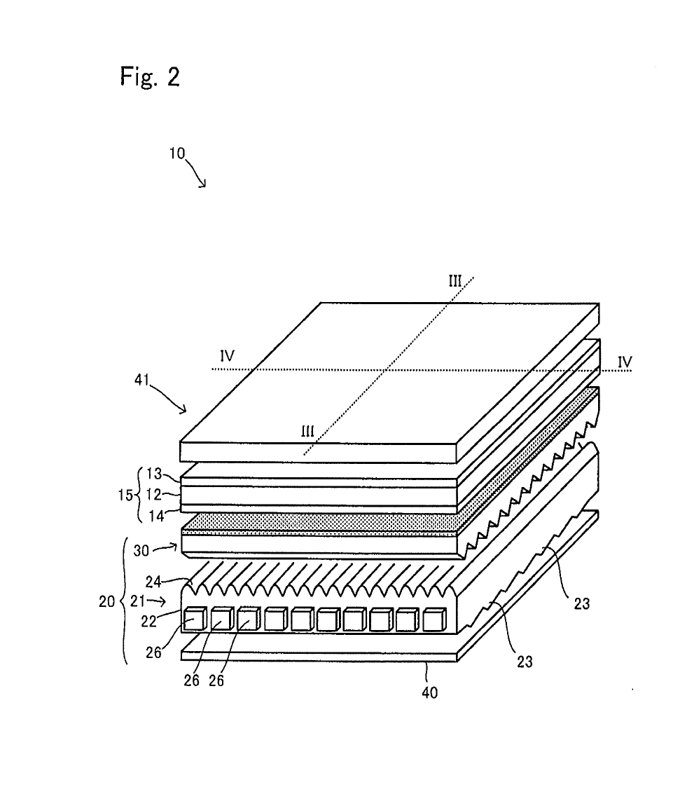

FIG. 1 is a perspective view of an exterior of a liquid crystal display device 1 according to a first embodiment. FIG. 2 is an exploded perspective view conceptually showing an image source unit 10 included in the liquid crystal display device 1. The liquid crystal display device 1 includes a housing 2, and the image source unit 10 is built into the housing 2. The housing 2 forms the outer shell of the liquid crystal display device 1, and accommodates most part of the members constituting the liquid crystal display device 1 thereinside. The housing 2 has an opening. From the opening, a so-called screen portion of the image source unit 10 is exposed, enabling images to be seen. In addition, the liquid crystal display device 1 includes various known structural members for functioning as a liquid crystal display device.

The liquid crystal device 1 includes an image source unit 10, and white light source lights emitted from a surface light source device 20 included in the image source unit 10 pass through a liquid crystal panel 15. Then, the white light source lights obtain image information and then the lights are provided to the observer side.

As can be seen from FIG. 2, the image source unit 10 includes the liquid crystal panel 15, the surface light source device 20, and a functional sheet 41. Here, the upper side of the drawing sheet is the observer side in FIG. 2.

The liquid crystal panel 15 includes an upper polarizing plate 13 arranged on the observer side, a lower polarizing plate 14 arranged on the surface light source device 20 side, and a liquid crystal layer 12 arranged between the upper polarizing plate 13 and the lower polarizing plate 14. The upper polarizing plate 13 and the lower polarizing plate 14 have a function to: divide incident light into two polarization components (P wave and S wave) that are orthogonal to each other; transmit the polarization component (for example, P wave) of one direction (a direction parallel to a transmission axis); and absorb the polarization component (or example, S wave) of the other direction (a direction parallel to an absorption axis) which is orthogonal to the above direction.

In the liquid crystal layer 12, an electric field may be applied on a region to region basis, each region forming one pixel. The orientation of the liquid crystal layer 12 in which the electric field is applied varies. The polarization component (for example, P wave) of a particular direction that is transmitted through the lower polarizing plate 14 arranged on the surface light source device 20 side (that is, the light input side), rotates the polarization direction thereof by 90° when passing through the liquid crystal layer 12 in which the electric field is applied, whereas maintaining the polarization direction thereof when passing through the liquid crystal layer 12 in which the electric field is not applied. As such, based on whether the electric field is applied in the liquid crystal layer 12 or not, it is possible to control whether the polarization component (P wave) of the particular direction transmitted through the lower polarizing plate 14 is further transmitted through the upper polarizing plate 13 arranged on the light output side of the lower polarizing plate 14, or is absorbed and blocked by the upper polarizing plate 13.

In this way, the liquid crystal panel 15 is configured to be capable of controlling, on a pixel to pixel basis, transmission or blocking of the light emitted from the surface light source device 20 to display an image. There are many types of liquid crystal panels, and any type of liquid crystal panels can be used without particular limitations.

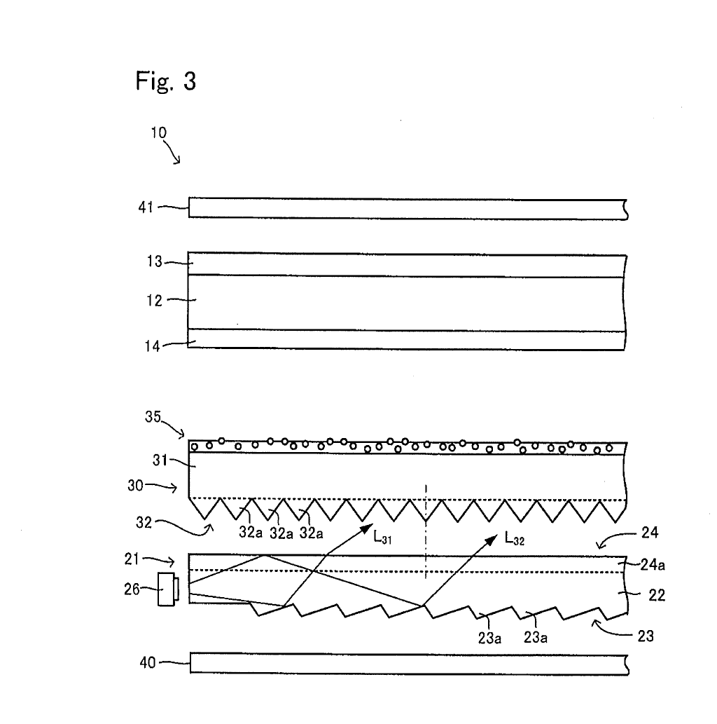

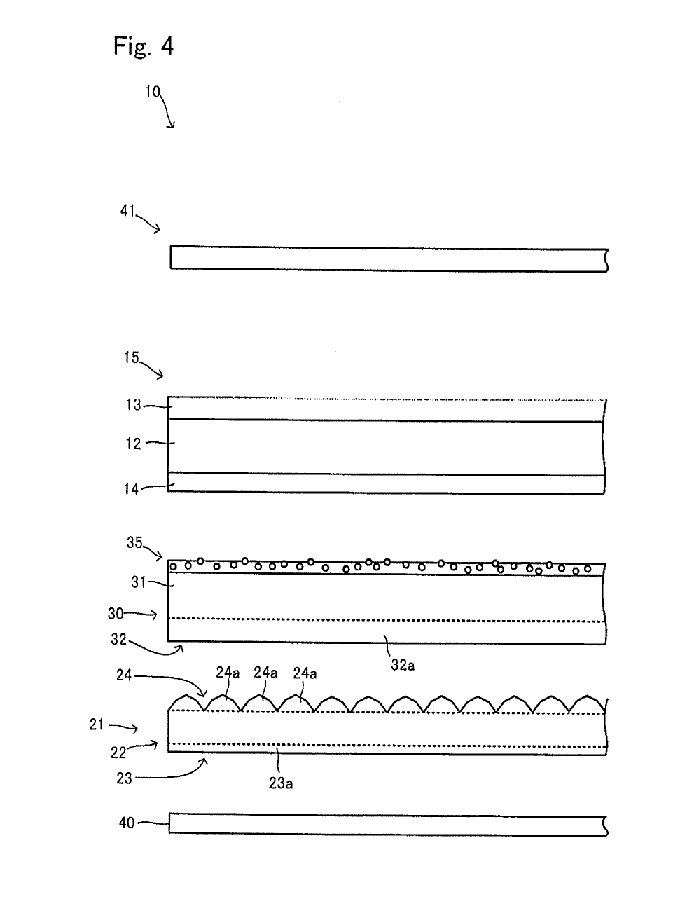

Next, the surface light source device 20 will be described. FIG. 3 shows a cross section in the thickness direction (vertical direction of the drawing sheet of FIG. 2) of the image source unit 10 along III-III in FIG. 2. FIG. 4 shows a cross section in the thickness direction of the image source unit 10 (vertical direction on the drawing sheet of FIG. 2) along IV-IV in FIG. 2.

The surface light source device 20 is arranged across the liquid crystal panel 15 from the observer side. The surface light source device 20 is a lighting device for emitting planar lights to the liquid crystal panel 15. As can be seen from FIGS. 2 to 4, in this embodiment, the surface light source device 20 is configured as an edge light type surface light source device, including a light guide plate 21, a light source 26, a prism sheet 30, and a reflection sheet 40.

As can be seen from FIGS. 2 to 4, the light guide plate 21 includes a base portion 22, a back face prism portion 23, and a unit optical element portion 24. The light guide plate 21 is a member formed in a plate shape as a whole, formed of a material having a light transmitting property. The unit optical element portion 24 is arranged on one plate face side of the light guide plate 21, to be a light output face side. The other plate face side is formed as a back face, where the back face prism portion 23 is formed. That is, the light guide plate 21 is provided with concavities and convexities on both sides.

As the materials of the base portion 22, the back side prism portion 23, and the unit optical element portion 24, various materials can be used. From the various materials, materials widely used as materials for prism sheets to be included in a display device, having excellent mechanical properties, optical properties, stability, and workability, and available at a low price can be used. For example, thermoplastic resins such as polymer resins having alicyclic structures, methacrylate resins, polycarbonate, polystyrene, acrylonitrile-styrene copolymers, methyl methacrylate-styrene copolymers, ABS resins, and polyether sulfone; and epoxy acrylate-based or urethane acrylate-based reactive resins (e.g. ionizing radiation curable resin) can be given.

The base portion 22 is a transparent portion to be the base of the back face prism portion 23 and the unit optical element portion 24, formed in a plate shape having a predetermined thickness.

The back face prism portion 23 has a concavo-convex shape formed on the back face side (plate face opposite from the face where the unit optical element portion 24 is to be arranged) of the base portion 22. As can be seen from FIGS. 2 to 4, in this embodiment, a plurality of unit back face prisms 23a each formed in a triangular column shape are arrayed. The unit back face prisms 23a are pillared members formed in a manner that the longitudinal direction of the pillar shapes extends along the face of the base portion 22. Two apexes of its triangle-shaped cross section are on the face of the base portion 22, and the remaining one apex is arranged in a manner to project from the base portion. The ridge line forming the projecting apex of the unit back face prism 23a extends in the horizontal direction of the drawing sheet of FIG. 2. The plurality of unit back face prisms 23a are arrayed having a predetermined pitch, in the direction orthogonal to the direction where the ridge line extends.

The cross section of the unit back face prism 23a in this embodiment is shaped in a triangle. However, the cross section is not limited thereto, and the cross section can be in any shape, for example, a polygonal shape such as a tetragon and a pentagon, a hemispherical shape, a part of a sphere, and a lens shape. A known form for the light guide plate can be applied to the shape of the cross section of the unit back face prism 23a.

The unit optical element portion 24 has a concavo-convex shape formed on the opposite side (on the face on the observer side) from the back face prism portion 23 of the base portion 22. The unit optical element portion 24 has a plurality of unit optical elements 24a which are arrayed convex portions. The unit optical element portions 24a are a portion to function as the light output face in a case where the light guide plate 21 is used for a surface light source device.

In this embodiment, as shown in FIGS. 2 and 4, each unit optical element 24a is a pillared element, whose cross section is formed in a pentagon shape, and whose ridge line extends in one direction keeping the cross section. The direction where the ridge line of the unit optical element 24a extends is a direction orthogonal to: the direction where the unit optical elements 24a are arrayed; and the direction where the ridge lines of the unit back face prisms 23a extend. That is, the unit optical elements 24a are configured in a manner that their ridge lines are orthogonal to the ridge lines of the unit back face prisms 23a in a planar view.

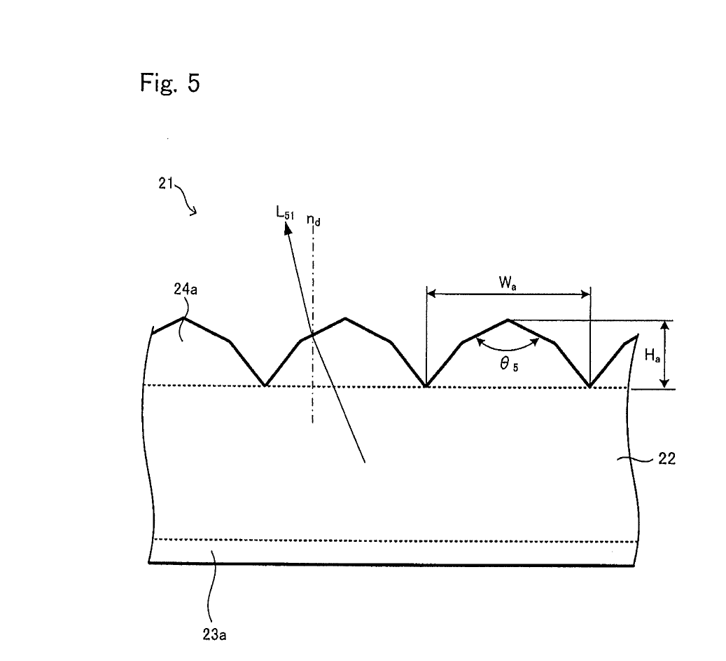

FIG. 5 is an enlarged view of a part of the light guide plate 21 of FIG. 4. The unit optical element 24a is formed in a pentagon shape. One side of the pentagon is on one face of the base portion 22. The other four sides form a convex portion projecting from the base portion 22.

Though the shape of the cross section in this embodiment is a pentagon, the cross section in this embodiment is not limited thereto. The cross section can be in any shape including polygonal shapes such as a triangle and a tetragon, a hemispherical shape, a part of a sphere, and a lens shape.

In addition, the unit optical element portion 24 is not necessarily arranged, and a flat surface of the base portion 22 can be a light output face.

The shapes (e.g. pentagon) in this specification include not only exact shapes (e.g. exact pentagon), but also shapes having errors in the forming and limitations in the manufacturing technique (e.g. approximate pentagon). Similarly, terms used in this specification for identifying other shapes and geometric conditions, for example, “parallel”, “orthogonal”, “oval”, and “circle” are not limited to their exact meanings, but they shall be read including some degree of errors with which similar optical functions can be expected.

The size of the light guide plate 21 having a configuration like the above can be set as follows, for example. As a specific example of the unit optical element 24a, its width Wₐ (see FIG. 5) along the plate face of the light guide plate 21 may be no less than 20 μm and no more than 500 μm. The height Hₐ (see FIG. 5) of the unit optical element 24a along the normal direction n_{d} to the plate face of the light guide plate 21 may be no less than 4 μm and no more than 250 μm. The vertex angle θ₅ (see FIG. 5) of the unit optical element 24a may be no less than 90° and no more than 150°.

On the other hand, the thickness of the base portion 22 may be no less than 0.20 mm and no more than 6 mm.

The light guide plate 21 having the above-described configuration can be produced by extrusion molding or by forming the unit back face prism 23a and/or the unit optical element 24a, on the base portion 22. As for the light guide plate 21 produced by extrusion molding, at least either one of the back face prism portion 23 and the unit optical element portion 24 may be integrally shaped with the base portion 22. In a case where the light guide plate 21 is produced by forming, the material of the back face prism portion 23 and the unit optical element portion 24 may be same as or different from the resin material of the base portion 22.

Back to FIGS. 2 to 4, the light source 26 will be described. The light source 26 is alight emitting source. Of two pairs of side faces of the base portion 22 of the light guide plate 21, the light source 26 is arranged on one side face of either one pair of side faces, the pair of side faces which are both ends of the extending direction of the ridge line of the unit optical element 24a. The kind of the light source is not particularly limited, and the light source can be configured in various forms, for example, a fluorescent lamp such as a linear cold cathode tube, a point-like LED (light emitting diode), or an incandescent light bulb can be used. In this embodiment, the light source 26 is formed by a plurality of LEDs, and is configured such that the output of each LED, that is, turning-on/off of each LED, and/or the brightness of each LED when turned on, can be adjusted by a control device not shown. The plurality of LEDs may be controlled all together, or may be controlled separately.

In this embodiment, the light source 26 is arranged on either one of a pair of side faces which are both ends of the extending direction of the ridge lines of the unit optical elements 24a, as one example. However, the light source may be arranged on both of the pair of side faces.

Next, the prism sheet 30 will be described. As can be seen from FIGS. 2 to 4, the prism sheet 30 in this embodiment includes: a body portion 31 formed in a sheet; a unit prism portion 32 arranged on a face of the body portion 31, the face facing to the light guide plate 21, that is, on the light input side face; and a light diffusing layer 35 arranged on the opposite side from the unit prism portion 32, that is, on the light output side face.

As described later, this prism sheet 30 has a function (light condensing function) of changing the moving direction of the light entered from the light input side, to emit the light from the light output side, and intensively increasing the brightness in the front direction (normal direction). This light condensing function is mainly fulfilled by the unit prism portion 32 of the prism sheet 30. In addition, the prism sheet 30 has a function of preventing the occurrence of interference fringes between the prism sheet 30 and the liquid crystal panel 15 and hiding defects such as scratches. This function is mainly fulfilled by the light diffusing layer 35.

As shown in FIGS. 2 to 4, the body portion 31 is a flat sheet-like member having a light transmitting property, which functions to support the unit prism portion 32 and the light diffusing layer 35.

As well shown in FIGS. 2 to 4, the unit prism portion 32 is arrayed in a manner that the plurality of unit prisms 32a are arranged along the light input side face, so that they project from the light input side face of the body portion 31. More specifically, the unit prisms 32a are pillared members formed in a manner to extend their ridge lines in a direction orthogonal to the arrangement direction thereof, while maintaining the predetermined cross-sectional shapes shown in FIG. 3. The extending direction of the ridge lines is orthogonal to the direction where the unit prisms 32a are arranged; the extending direction is also a direction deviated by an angle no less than 80° to no more than 100° from the extending direction of the ridge lines of the unit optical elements 24a of the above-described light guide plate 21. More preferably, the extending direction is deviated by an angle no less than 85° and no more than 95°. As such, the extending direction of the ridge lines of the unit prisms 32a and the extending direction of the ridge lines of the unit optical elements 24a are orthogonal to each other, when the display device is seen from the front.

Further, it is preferable that the extending direction of the ridge lines of the unit prisms 32a crosses the transmission axis of the lower polarizing plate 14 of the liquid crystal panel 15, when it is observed from the front. More preferably, the longitudinal direction of the unit prism 32a of the prism sheet 30 crosses the transmission axis of the lower polarizing plate 14 of the liquid crystal panel 15 at an angle larger than 45° and smaller than 135° on the face parallel to the display face of the display device (the face parallel to the sheet face of the body portion 31 of the prism sheet 30). The angle mentioned here means a smaller angle of the angles made by the longitudinal direction of the unit prisms 32a and the transmission axis of the lower polarizing plate 14, that is, an angle of 180° or less. Particularly in the present embodiment, the longitudinal direction of the unit prisms 32a of the prism sheet 30 is preferably orthogonal to the transmission axis of the lower polarizing plate 14 of the liquid crystal panel 15; and the arrangement direction of the unit prisms 32a of the prism sheet 30 is preferably parallel to the transmission axis of the lower polarizing plate 14 of the liquid crystal panel 15.

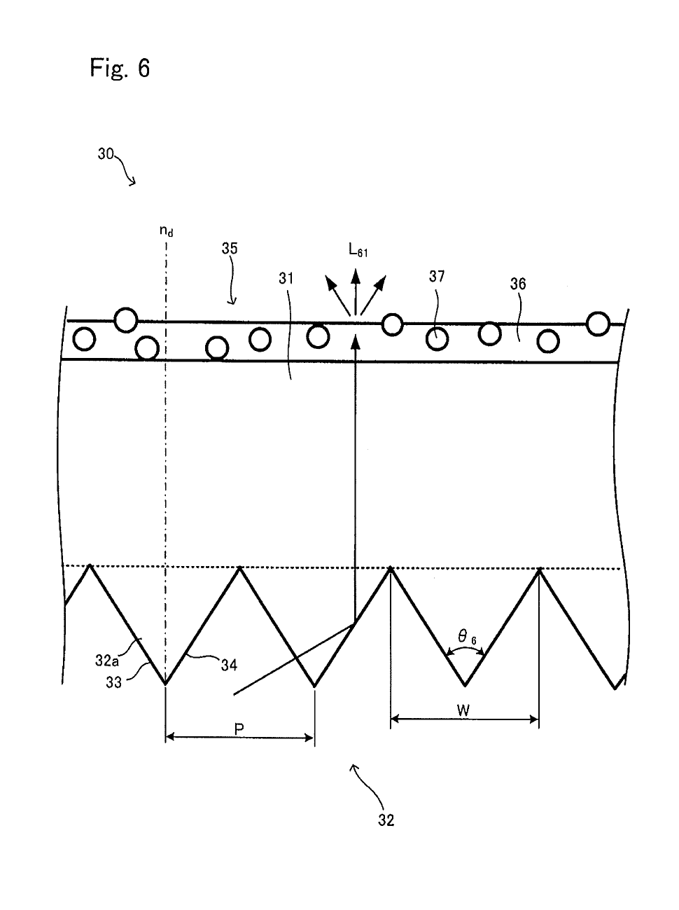

Next, the cross-sectional shape of the unit prism 32a in the arrangement direction thereof will be described. FIG. 6 is an enlarged view of a part of the prism sheet 30 shown in FIG. 3. Herein, “n_{d}” shows the normal direction of the sheet face of the body portion 31.

As can be seen from FIG. 6, in this embodiment, the unit prism 32a has an isosceles triangular cross section projecting from the body portion 31 to the light guide plate 21 side. That is, the width of the unit prism 32a in a direction parallel to the sheet face of the body portion 31 gets smaller as it gets farther from the body portion 31 along the normal direction n_{d} of the body portion 31.

In this embodiment, the outer contour of the unit prism 32a is line symmetrical with an axis parallel to the normal direction n_{d} of the body portion 31 as an symmetrical axis; and the cross section of the unit prism 32a is an isosceles triangle. With this configuration, the brightness on the light output face of the prism sheet 30 can have a symmetrical angle distribution of brightness around the front direction, in the plane parallel to the arrangement direction of the unit prisms 32a.

Here, the size of the unit prism 32a is not particularly limited, and it is preferable that a vertex angle θ₆ (see FIG. 6) at the tip of the convex portion of the unit prism 32a is no more than 80°. This makes it possible to obtain a more proper light condensing property, with the arrangement structure of the unit prisms 32a arranged facing to the light output face of the light guide plate 21. More preferably, the vertex angle θ₆ is no less than 60° and no more than 80°. The width W of the bottom base is preferably same as the pitch P. The pitch P of the adjacent unit prisms 32a is no less than 10 μm. Other determinations regarding the pitch P will be described later.

In this embodiment, the unit prism having the triangular-shaped cross section has been described as the above; however, the cross-sectional shape is not limited thereto. It may be a trapezoidal shape, changing the vertex part of the triangle into a shorter upper base. Further, one or/and the other oblique line of the triangle may be a polygonal line or curved line. Thus the shape of the cross section may be in a polygonal shape such as a tetragon or a pentagon.

Next, the light diffusing layer 35 will be described. The light diffusing layer 35 is a layer formed of a light transmitting resin layer 36 containing a lot of light diffusing particles 37 which have a refractive index different from that of the light transmitting resin layer 36. Part of the light diffusing particles 37 projects from the surface of the light transmitting resin layer 36, which makes the surface of the light diffusing layer 35 have fine asperities.

The resin used for the light transmitting resin layer 36 is not particularly limited as long as the resin has a light transmitting property, and can disperse and at the same time hold the light diffusing particles 37. Examples of such a resin include: thermoplastic resins such as polyamide-based resins, polyurethane-based resins, polyester-based resins, and acryl-based resins; thermosetting resins; and active energy ray curable resins (ionizing radiation curable resins).

As the light diffusing particles 37, cross-linked organic fine particles such as acryl-styrene copolymers, polymethyl methacrylate, polystyrene, polyurethane, benzoguanamine, and melamine; resin fine particles such as silicone; and inorganic fine particles such as silica, alumina, and glass.

The light diffusing particles to be used do not have to be one kind, but two or more kinds may be mixed to be used. The shape of each light diffusing particle 37 may be a spherical form or may be in indeterminate forms. The particle size distribution may be monodisperse or polydisperse, and preferable conditions may be adequately selected.

Here, the surface roughness of the light diffusing layer 35 is no less than 0.038 (μm) by Ra (μm) (JIS B 0601 (2001) arithmetic average roughness), and satisfies the following formula (1).

Ra≦−0.0296·P+1.9441 (1)

Here, P is the pitch P (μm) of adjacent unit prisms 32a of the unit prism portion 32 described above. That is, Ra is no less than 0.038 μm and at the same time Ra satisfies the above formula (1). The pitch P of the unit prism 32a satisfies the above formula (1) in the range of no less than 10 μm.

If Ra of the light diffusing layer 35 is smaller than 0.038 μm, the light diffusing layer 35 does not function as a light diffusing layer, and cannot exert a concealing property. If the pitch P of the unit prism 32a is less than 10 μm, it is not possible to practically obtain a product which can be produced on a large scale, due to the limitations of tools for producing molds, and the limitations of the processing accuracy in molding.

This makes it possible to inhibit scintillations, to have a concealing property, and at the same time to inhibit degradation of brightness (obtain a low haze value). Thus, a prism sheet, having a good use efficiency of lights in addition to the effects expected to conventional light diffusing layers, can be obtained. The derivation of the formula (1) will be described later.

Here, the haze (total haze) of the prism sheet 30 is dominated from the light diffusing layer 35. By satisfying the above formula (1), it is possible to obtain the above effects, even though the haze of the prism sheet 30 is no more than 45%.

Specific ways for making the light diffusing layer have above properties are not particularly limited, and known means can be used. For example, a method of changing the ratio of the light diffusing particles and a light transmitting resin, a method of adjusting the particle size of the light diffusing particles of the light diffusing layer, and the like may be given.

In this embodiment, an example where light diffusing particles are used in the light diffusing layer is described. However, the light diffusing layer is not limited thereto, and the light diffusing layer may be formed of a layer having a face with fine asperities (so-called mat face). This kind of light diffusing layer does not have light diffusing particles, but has fine asperities formed on its surface. For producing this kind of light diffusing layer, known methods can be applied such as transcribing fine asperities from a mold.

The prism sheet 30 having a structure like the above is produced for example by: providing in first the light diffusing layer 35 on a base material to be the body portion 31; and after that forming the unit prism portion 32. The light diffusing layer 35 can be formed by: applying a light transmitting resin before curing where the light diffusing particles 35 are dispersed, to one face of a base material to be the body portion 31; and curing it.

Next, the unit prism portion 32 is shaped on the other face of the base material to be the body portion 31, whereby the prism sheet 30 is formed.

As the material for the body portion 31 and the unit prism portion 32, various materials may be used. However, materials widely used for optical sheets to be included in display devices, having excellent mechanical properties, optical properties, stability, workability and the like, and are available at low costs may be preferably used. Examples thereof include: transparent resins whose main component is one or more of acryl, styrene, polycarbonate, polyethylene terephthalate, acrylonitrile, and the like; and epoxy acrylate-based reactive resins and urethane acrylate-based reactive resins (e.g. ionizing radiation curable resins).

For the prism sheet described here, an example where the light diffusing layer 35 is directly layered on the body portion 31 is described. However, the prism sheet 30 is not limited thereto, and the light diffusing layer 35 needs only to be arranged on the opposite side of the body portion 31 from the side where the unit prism portion 32 is arranged. Thus, the body portion 31 and the light diffusing layer 35 may be separately positioned so that an air layer is formed therebetween, or another functional layer may be provided between the body portion 31 and the light diffusing layer 35.

Similarly, the body portion 31 and the unit prism portion 32 may be separately positioned so that an air layer is formed therebetween, or another functional layer may be provided between the body portion 31 and the unit prism portion 32.

Back to FIGS. 2 to 4, the reflection sheet 40 of the surface light source device 20 will be described. The reflection sheet 40 is a member to reflect the light emitted from the back face of the light guide plate 21 to make the light enter the light guide plate 21 again. The material constituting the reflection sheet 40 is not particularly limited, and films having light reflection properties, such as a white film (Lumirror (registered trademark) E6SR, manufactured by TORAY INDUSTRIES, INC.), multilayer film reflection film (ESR, manufactured by 3M Japan Limited), and silver deposition film (Kiraraflex (registered trademark), manufactured by Kyoto Nakai shoji Co., Ltd.) may be given as examples. More preferably, a sheet which can realize specular reflection, for example a sheet made of a material having a high reflection ratio, such as metal, and a sheet including a thin film (e.g. metal thin film) made of a material having a high reflection ratio as a surface layer, can be applied. This makes it possible to improve availability of lights, whereby it is possible to improve the use efficiency of energy.

Back to FIG. 2, the functional sheet 41 will be described. The functional sheet 41 is a sheet used for normal liquid crystal display devices, having various functions. Examples thereof include a sheet correcting color tones, a sheet having anti-glare functions, a sheet preventing reflections, and a hard coat sheet.

Each structure as described above is arranged as follows, to form the image source unit 10. That is, as can be seen from FIGS. 2 to 4, of two pairs of side faces of the base portion 22 of the light guide plate 21, the light source 26 is arranged on one side face of either one pair of side faces, the pair of side faces which are both ends of the extending direction of the ridge lines of the unit optical elements 24a. In this embodiment, a plurality of light sources 26 are arranged in the direction where the unit optical elements 24a are arrayed.

The reflection sheet 40 is arranged on the back face prism portion 23 side of the light guide plate 21. On the other hand, the prism sheet 30 is arranged on the unit optical element portion 24 side of the light guide plate 21. The prism sheet 30 is arranged in such a manner that the ridge lines of the unit prisms 32a of the prism sheet 30 is orthogonal to the ridge lines of the unit optical elements 24a of the light guide plate 21 in the front view. At this time, the prism sheet 30 is arranged in such a manner that the light input face 33 of the unit prisms 32a is on the light source 26 side, and the opposite side is to be the reflection face 34.

The liquid crystal panel 15 is arranged on the opposite side of the prism sheet 30 from the light guide plate 21, and the functional sheet 41 is arranged on the observer side of the liquid crystal panel 15.

As shown in FIG. 1, the image source unit 10 having such a configuration is put in the housing 2 with other necessary equipments, to be the liquid crystal display device 1.

Next, the functions of the liquid crystal display device 1 having the above configuration will be described with an example of the light path. However, the example of the light path is conceptually shown, and does not strictly show the degrees of reflection and refraction, and the like.

First, the light emitted from the light source 26 enters the light guide plate 21 through the light input face on the side face of the light guide plate 21, as shown in FIG. 3. FIG. 3 shows, as one example, light paths of the lights L₃₁ and L₃₂ entered the light guide plate 21 from the light source 26.

As shown in FIG. 3, the lights L₃₁ and L₃₂ that have entered the light guide plate 21 are totally reflected on the face of the unit optical element portion 24 of the light guide plate 21 and on the face of the back face prism portion 23 opposite thereto, due to the refractive index difference from the air; and the light emitted from the back face, which is not shown, is brought back to the light guide plate 21 by the reflection sheet 40. Repeating the above reflections, the lights move in the extending direction (light guiding direction) of the ridge lines of the unit optical elements 24a.

Here, the back face prism portion 23 is formed on the back face side of the base portion 22 of the light guide plate 21. Therefore, as shown in FIG. 3, the moving directions of the lights L₃₁ and L₃₂ moving through the light guide plate 21 are changed sequentially by the back face prism portion 23, and thus, in some cases, the lights L₃₁ and L₃₂ enter the unit optical element portion 24 at an incident angle less than a total reflection critical angle. In these cases, the lights may be emitted from the face of the unit optical element portion 24 of the light guide plate 21. The lights L₃₁ and L₃₂ emitted from the unit optical element portion 24 move toward the prism sheet 30 arranged on the light output side of the light guide plate 21.

This makes the lights moving through the light guide plate 21 exit little by little from the light output face. This enables a uniform light amount distribution, along the light guiding direction, of the light emitted from the unit optical element portion 24 of the light guide plate 21.

Here, the unit optical element portion 24 of the light guide plate 21 shown in the drawings is constituted by a plurality of unit optical elements 24a; and the cross-sectional shape of each unit optical elements 24a is a triangle, a shape in which a vertex angle of a triangle is chamfered, a pentagon, or other polygonal shapes. With any shapes, the unit optical elements 24a are configured to have faces inclined against the light guiding direction of the light guide plate 21. Therefore, the lights emitted from the light guide plate 21 through the unit optical element 24a are refracted, as shown by the light L₅₁ in FIG. 5, when emitted from the light guide plate 21. This refraction causes the light to come closer to the normal line n_{d} to the sheet face, in the arrangement direction of the unit optical elements 24a (a refraction whose angle with respect to the normal line n_{d} becomes smaller). By this effect, as to the light component along the direction orthogonal to the light guiding direction, the unit optical element portion 24 can concentrate the moving direction of the transmitted light into the front direction side. Namely, the unit optical element portion 24 exerts a light condensing effect on the light component along the direction orthogonal to the light guiding direction.

In this way, the emission angle of the light emitted from the light guide plate 21 is concentrated into a narrow angle range around the front direction, in the plane parallel to the arrangement direction of the unit optical elements 24a of the light guide plate 21.

The light emitted from the light guide plate 21 thereafter enters the prism sheet 30. The unit prisms 32a of the prism sheet 30, like the unit optical elements 24a of the light guide plate 21, exert a light condensing effect on the transmitted light by the refraction and total reflection on the light input face of the unit prisms 32a. However, the light whose moving direction is changed in the prism sheet 30 is a component in the plane of the prism sheet 30 orthogonal to the arrangement direction of the unit prisms 32a; and differs from the light component concentrated in the light guide plate 21. That is, as shown by L₆₁ in FIG. 6, the light that has entered the unit prism 32a is totally reflected at the interface between the unit prism 32a and the air, based on the refractive index difference between them. At this time, the oblique line of the unit prism 32a is inclined at θ₆/2 against the normal line n_{d} to the sheet face; therefore the reflected light at the interface has an angle closer to the normal line n_{d} than the incident light.

That is, in the light guide plate 21, the moving direction of the light is concentrated into the narrow angle range around the front direction, in the plane parallel to the arrangement direction of the unit optical elements 24a of the light guide plate 21. On the other hand, in the prism sheet 30, the moving direction of the light is concentrated into the narrow angle range around the front direction, in the plane parallel to the arrangement direction of the unit prisms 32a of the prism sheet 30. Therefore, it is possible, by the optical effect exerted in the prism sheet 30, to further enhance the front direction brightness without degrading the front direction brightness already enhanced in the light guide plate 21.

The light L₆₁ totally reflected by the unit prism 32a transmits the body portion 31 and is diffused at the light diffusing layer 35, to be emitted from the prism sheet 30. At this time, the degradation of brightness is inhibited. Therefore, it is possible to emit the light having a high front brightness whose direction is changed by the unit prism 32a, with an efficient light brightness. In addition, the concealing property is sufficiently secured, since the image clarity is kept low.

The scintillation is also inhibited by the prism sheet 30.

The light emitted from the prism sheet 30 enters the lower polarizing plate 14 of the liquid crystal panel 15. The lower polarizing plate 14 transmits one of the polarization components of the incident light, and absorbs the other polarization component. The light transmitted through the lower polarizing plate 14 selectively passes through the upper polarizing plate 13 in accordance with the state of the application of the electric field on each pixel. In this manner, the liquid crystal panel 15 selectively transmits the light from the surface light source device 20 on a pixel to pixel basis, thereby enabling the observer of the liquid crystal display device to observe the image.

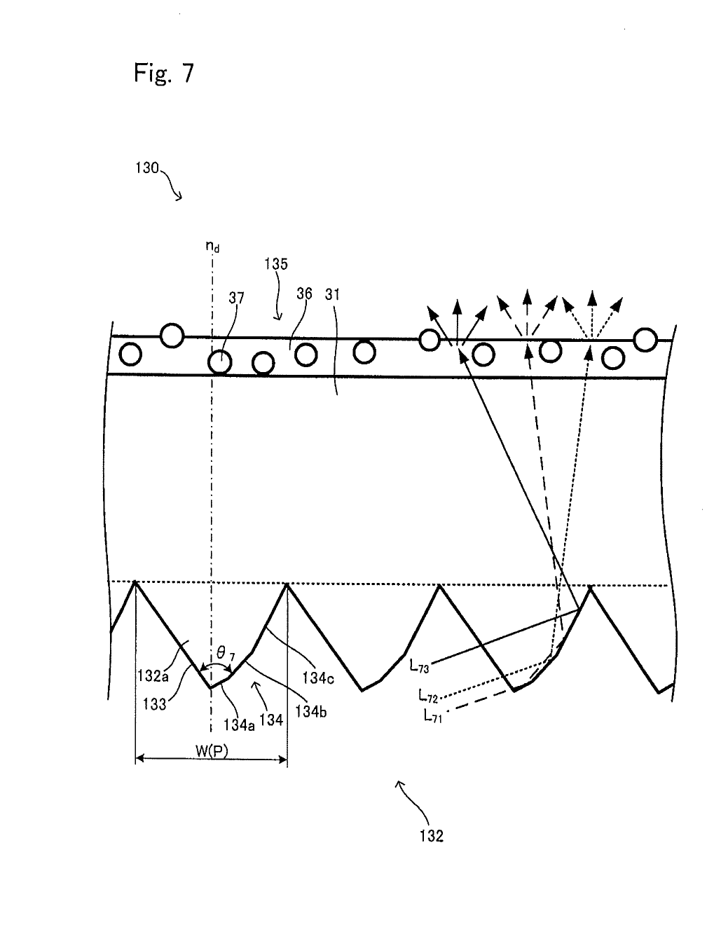

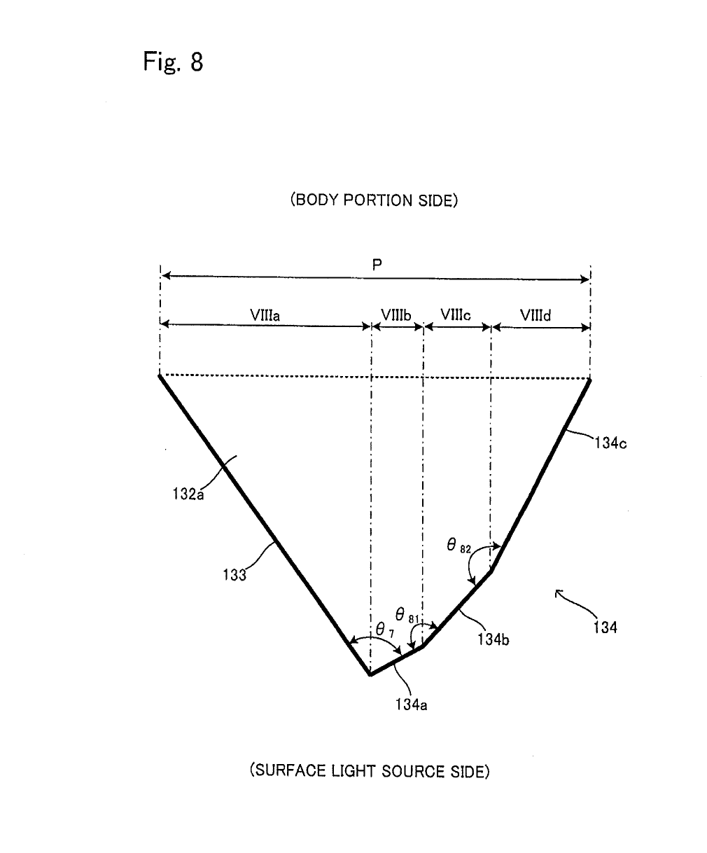

Next, a second embodiment will be described. FIGS. 7 and 8 show views for explanation. The second embodiment is an example where a prism sheet 130 is applied instead of the prism sheet 30 described above, more specifically, an example where a unit prism portion 132, in which a unit prism 132a is applied instead of the unit prism 32a, is applied, and in accordance with this, a light diffusing layer 135 is used instead of the light diffusing layer 35. Thus the prism sheet 130 will be described here. It is noted that, for the same configurations as in the first embodiment described above, same signs are used and the descriptions thereof are omitted. FIG. 7 is a view seen from the same viewpoint as that of FIG. 6, in which n_{d} is the normal direction to the sheet plane of the body portion 31. FIG. 8 is an enlarged view of one unit prism 132a in FIG. 7.

As can be seen from FIGS. 7 and 8, the unit prism 132a has a predetermined cross section projected from the body portion 31 to the light guide plate 21 side. That is, the cross section has a tapered shape where the width of the unit prism 132a in the direction parallel to the sheet plane of the body portion 31 gets smaller as the distance from the main portion along the normal direction n_{d} of the body portion 31 increases.

More specifically, in the outer contour of the unit prism 132a, one face, across the tip which is the apex of the tapered shape, is made to be a light input face 133. In this embodiment, the light input face 133 is formed by a straight line having a constant obliquity at the cross section shown in FIGS. 7 and 8. That is, the light input face 133 is formed of one face. The light input face 133 faces to the light source 26 side in a surface light source device, and most lights which enter the prism sheet 130 enter from the light input face 133.

On the other hand, the other face opposite from the light input face 133, across the tip which is the apex of the tapered shape, is a reflection face 134. The reflection face 134 is formed of a polygonal line consisting of three sides each having a different obliquity at the cross section shown in FIGS. 7 and 8. That is, the reflection face 134 is formed of continuing three plane faces 134a, 134b and 134c, each having a different incline angle to the normal line n_{d}. The reflection face 134 faces to the opposite side from the light source 26 in a surface light source device, and totally reflects the light entered from the light input face 133 and changes the direction of the light in the light output face side.

Here, the size of the unit prism 132a is not particularly limited. However, the vertex angle θ₇ (see FIG. 7) of the tip at the cross section of the unit prism 132a is preferably no more than 80°. This makes it possible to obtain a more appropriate light condensing property, with the arrangement configuration of the unit prisms 32a arranged facing to the light output face of the light guide plate 21. More preferable vertex angle θ₇ is no less than 60° and no more than 78°. The width W of the base is preferably the same as the pitch P. The pitch P between the adjacent unit prisms 32a is no less than 10 μm. Other determinations regarding the pitch P will be described later.

Though not particularly limited, the size of the reflection face 134 is preferably configured as follows. That is, as shown in FIG. 8, the bend angle θ₈₁ on the tip side of the unit prism at the reflection face 134 is preferably no less than 165° and no more than 179°, and the bend angle θ₈₂ on the base end side is preferably no less than 165° and no more than 179°. The distance between the peaks of the unit prisms in the pitch direction of the unit prisms 132a is defined as shown by VIIIa to VIIId shown in FIG. 8. Setting the pitch P as the ratio of 1.000 (standard ratio), each portion of VIIIa to VIIId is preferably within the following range of ratio.
0.525≦VIIIa≦0.545
0.100≦VIIIb≦0.120
0.130≦VIIIc≦0.150
0.205≦VIIId≦0.225

On the other hand, the light diffusing layer 135 is a layer consisting of the light transmitting resin layer 36 containing a lot of light diffusing particles 37 having a different reflective index from that of the light transmitting resin layer 36. Part of the light diffusing particles 37 projects from the surface of the light transmitting resin layer 36, which makes the surface of the light diffusing layer 135 have fine asperities. Therefore, the light diffusing layer 135 is same as the above-described light diffusing layer 35 in this point, and the same materials used for the light diffusing layer 35 can be used for the light diffusing layer 135.

However, the surface roughness of the light diffusing layer 135 in this embodiment is no less than 0.038 (μm) by Ra (μm) (JIS B0601 (2001) arithmetic average roughness), and satisfies the following formula (2).

Ra≦−0.0263·P+2.0537 (2)

Here, P is the pitch (μm) between the adjacent unit prisms 132a of the above-described unit prism portion 132. That is, Ra is no less than 0.038 μm and in the range satisfying the formula (2). The pitch P of the unit prism 132a satisfies the above formula (2) in the range of no less than 10 μm.

If Ra of the light diffusing layer 135 is smaller than 0.038 μm, the light diffusing layer 135 does not function as a light diffusing layer, and cannot exert the concealing property. If the pitch P of the unit prism 132a is less than 10 μm, it is not possible to practically obtain a product which can be produced on a large scale, due to the limitations of tools for producing molds, and the limitations of the processing accuracy in molding.

This makes it possible to obtain a prism sheet inhibiting scintillations, having a concealing property, and at the same time having a good use efficiency of lights. The derivation of the formula (2) will be described later.

The image source unit including the prism sheet 130 having the configuration as described above is configured modeled after the example of the above-described image source unit 10. That is, as can be seen from FIGS. 2 to 4, of two pairs of side faces of the base portion 22 of the light guide plate 21, the light source 26 is arranged on one side face of either one pair of side faces, the pair of side faces which are both ends of the extending direction of the ridge lines of the unit optical elements 24a. In this embodiment, a plurality of light sources 26 are arranged in the arrangement direction of the unit optical elements 24a.

The reflection sheet 40 is arranged on the back face prism portion 23 side of the light guide plate 21. On the other hand, the prism sheet 130 is arranged on the unit optical element portion 24 side of the light guide plate 21. The prism sheet 130 is arranged in such a manner that the ridge lines of the unit prisms 132a of the prism sheet 130 are orthogonal to the ridge lines of the unit optical elements 24a of the light guide plate 21 in the front view. At this time, the prism sheet 130 is arranged in such a manner that the light input face 133 of the unit prism 132a is on the light source 26 side, and the opposite side is to be the reflection face 134.

The liquid crystal panel 15 is arranged on the opposite side of the prism sheet 130 from the light guide plate 21, and the functional sheet 41 is arranged on the observer side of the liquid crystal panel 15.

The liquid crystal display device like this including the prism sheet 130 functions as follows. The function will be described with an example of the light path. However, the example of the light path is conceptually shown, and does not strictly show the degrees of the reflection and refraction, and the like.

The light path of the light emitted from the light source 26 until the light is emitted from the light guide plate 21 is same as the example of the light path of the lights L₃₁ and L₃₂ (see FIG. 3) described above.

The light emitted from the light guide plate 21 thereafter enters the prism sheet 130. The unit prism 132a of the prism sheet 130 exerts, similar to the unit optical element 24a of the light guide plate 21, a light condensing function on the transmitted light, by the refraction and total reflection at the light input face of the unit prisms 32a. However, the light whose moving direction is changed by the prism sheet 130 is a component in the plane of the prism sheet 130 orthogonal to the arrangement direction of the unit prisms 132a; and differs from the light component concentrated in the light guide plate 21. That is, as shown by L₇₁, L₇₂ and L₇₃ in FIG. 7, the light that has entered the unit prism 132a is totally reflected at the interface between the unit prism 132a and the air, based on the refractive index difference between them. At this time, the reflected light at the interface has an angle closer to the normal line n_{d} than the incident light, based on the oblique lines of the faces 134a, 134b and 134c of the reflection face 134.

Further, because the reflection face 134 is formed of three faces of 134a, 134b and 134c, each having a different inclined angle, for examples the lights L₇₁, L₇₂ and L₇₃ entered in a parallel manner differ their light emission angles, depending on the face where the lights are reflected, among the faces 134a, 134b and 134c of the reflection face 134. The light L₇₁ is reflected at the faces 134a and 134c, the light L₇₂ is reflected at the face 134b, and the light L₇₃ is reflected at the face 134c, whereby it is possible to emit the reflection light further diffused than the incident light. This eases the light and dark of the reflection light having a cycle of the pitch P of the unit prism 132. Specifically, in a case where the light source is arranged on one side only, there is a high possibility of having light portions and dark portions, because there is little light emitted from the light input face even though the reflection light is emitted from the reflection face. In contrast, with the configuration of the reflection face as this embodiment, the effect can be increased along with the relationship with the above formula (2).

As described above, the light guide plate 21 concentrates the moving direction of the light into a narrow angle range around the front direction, in the plane parallel to the arrangement direction of the unit optical elements 24a of the light guide plate 21. On the other hand, in the prism sheet 130, the moving direction of the light is concentrated into the narrow angle range around the front direction, in the plane parallel to the arrangement direction of the unit prisms 132a. Therefore, it is possible, by the optical effect exerted in the prism sheet 130, to further enhance the front direction brightness without degrading the front direction brightness already enhanced in the light guide plate 21.

At this time, the light adequately diffused is reflected by the function of the reflection face 134 of the prism sheet 130.

The lights L₇₁, L₇₂ᵣ and L₇₃ totally reflected by the unit prism 132a pass through the body portion 31, are diffused by the light diffusing layer 135, and are emitted from the prism sheet 30. At this time, it is possible to efficiently emit the light whose direction is changed by the unit prism 132a, with brightness. In addition, the concealing property is sufficiently secured, since the image clarity is kept low.

Further, the scintillation is inhibited by the prism sheet 130.

The light emitted from the prism sheet 130 enters the lower polarizing plate 14 of the liquid crystal panel 15. The lower polarizing plate 14 transmits one of the polarization components of the incident light, and absorbs the other polarization component. The light transmitted through the lower polarizing plate 14 selectively passes through the upper polarizing plate 13 in accordance with the state of the application of the electric field on each pixel at the crystal liquid layer 12. In this manner, the liquid crystal panel 15 selectively transmits the light from the surface light source device on a pixel to pixel basis, thereby enabling the observer of the liquid crystal display device to observe the image.

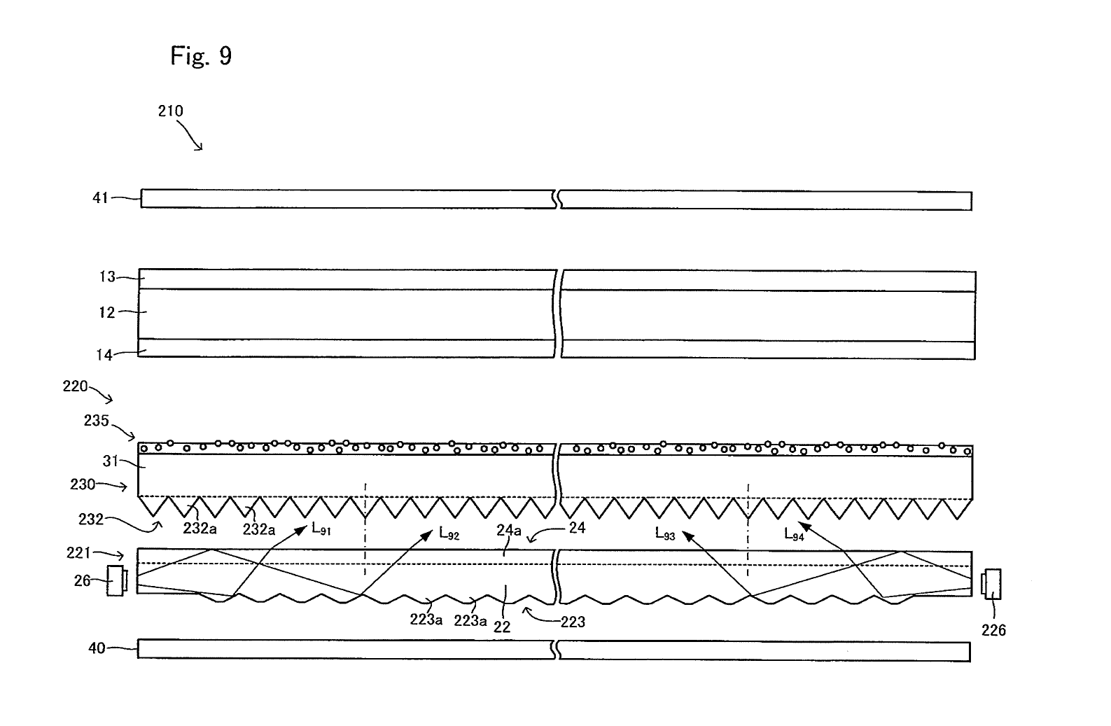

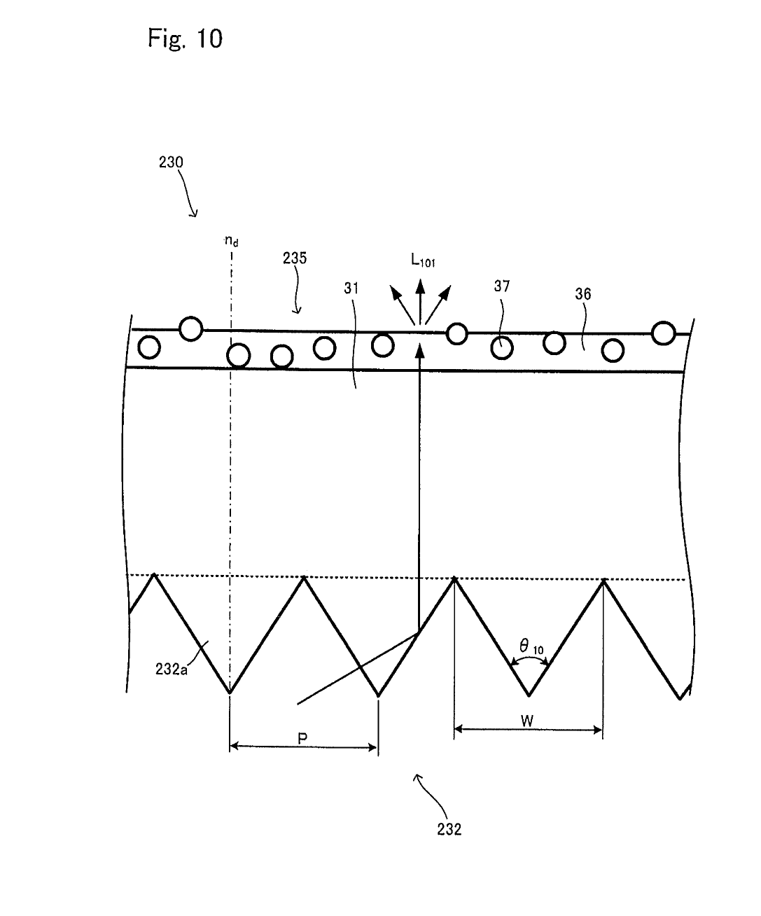

Next, a third embodiment will be described. The third embodiment includes a configuration where a prism sheet 230 of an image light source unit 210 exerts a high potent effect on the two-lamp system of light sources. The configuration will be described in detail below. FIGS. 9 and 10 are views for explanation. FIG. 9 is an exploded cross-sectional view of the image source unit 210, seen from the same view point as that of FIG. 3. FIG. 10 is a view seen from the same view point as that of FIG. 6.

The image source unit 210 includes the liquid crystal panel 15, a surface light source device 220, and the functional sheet 41. In FIG. 1, the upper side of the drawing sheet is the observer side. The liquid crystal panel 15 and the functional sheet 41 are same as that of the image source unit 10, therefore the same signs as that of the image source unit 10 are used and descriptions thereof are omitted.

The surface light source device 220 is a lighting device arranged on a side of one face of the liquid crystal panel 15, the face being opposite from the observer side, and emits planar light to the liquid crystal panel 15. As can be seen from FIG. 9, the surface light source device 220 is configured to be an edge-light type surface light source device, and includes a light guide plate 221, a first lamp side light source 26, a second lamp side light source 226, a prism sheet 230, and a reflection sheet 40.

As can be seen from FIG. 9, the light guide plate 221 includes the base portion 22, a back face prism portion 223, and the unit optical element portion 24. The base portion 22 and the unit optical element 24 are same as in the light guide plate 21 described above, therefore the same signs as that of the light guide plate 21 are given, and descriptions thereof are omitted.

The back face prism portion 223 has a concavo-convex shape formed on the back face side (plate face opposite from the face where the unit optical element portion 24 is to be arranged) of the base portion 22. As can be seen from FIG. 9, a plurality of unit back face prisms 223a each formed in a square column shape (column having a trapezoid cross section) are arrayed. The unit back face prisms 223a are pillared members formed in a manner that the ridge lines of the convex portions extend perpendicular to the drawing sheet of FIG. 9. A plurality of unit back face prisms 223a are arrayed having a predetermined pitch in the direction orthogonal to the extending direction. Each unit back face prism 223a of this embodiment has a cross section having a tetragon shape (trapezoid). However, the cross-sectional shape is not limited thereto, and may be in any forms, such as a triangular shape and another polygonal shape, a hemispherical shape, a part of sphere, and a lens shape.

Next, the light sources 26 and 226 will be described. As can be seen from FIG. 9, the first lamp side light source 26 and the second lamp side light source 226 are provided in this embodiment.

The first lamp side light source 26 is a light source arranged, of two pairs of side faces of the base portion 22 of the light guide plate 21, on one side of either one pair of side faces which are both ends in the longitudinal direction. The longitudinal direction is the extending direction of the ridge lines of the unit optical elements 24a.

The second lamp side light source 226 is a light source arranged, of the two pairs of side faces of the base portion 22 of the light guide plate 21, on the other side of either one pair of side faces which are both ends in the longitudinal direction. The longitudinal direction is the extending direction of the unit optical elements 24a. The second lamp side light source 226 emits light toward the first lamp side light source 26 side.

The kinds of the first lamp side light source 26 and the second lamp side light source 226 are not particularly limited, and for example, a fluorescent lamp such as a linear cold cathode tube, a point-like LED (light emitting diode), or an incandescent light bulb can be used.

Next, the prism sheet 230 will be described. As can be seen from FIG. 9, the prism sheet 230 includes: the body portion 31 formed in a sheet; a unit prism portion 232 arranged on a face of the body portion 31 which faces to the light guide plate 221, that is, on the light input side face; and a light diffusing layer 235 arranged on the other side of the unit prism portion 232, that is, on the light output side face.

This prism sheet 230, similar to the above description, has a function (light condensing function) of changing the moving direction of the light entered from the light input side to emit the light from the light output side, and intensively increasing the brightness in the front direction (normal direction). This light condensing function is mainly fulfilled by the unit prism portion 232 of the prism sheet 230. In addition, the prism sheet 230 has a function to prevent the occurrence of interference fringes between the prism sheet 230 and the liquid crystal panel 15, and hiding defects such as scratches. These functions are mainly fulfilled by the light diffusing layer 235.

As shown in FIG. 9, the body portion 31 is a transparent member formed in a flat sheet-like shape having a light transmitting property, functioning to support the unit prism portion 232 and the light diffusing layer 233.

As well shown from FIG. 9 and the above descriptions of other embodiments, the unit prism portion 232 is formed such that the plurality of unit prisms 232a are arrayed along the light input side face of the body portion 31. More specifically, the unit prisms 232a are pillared members formed in a manner to extend their ridge lines in a direction orthogonal to the arrangement direction thereof, while maintaining the predetermined cross-sectional shapes shown in FIG. 9. The extending direction of the ridge lines is orthogonal to the direction where the unit prisms 232a are arranged; the extending direction is also a direction deviated by an angle no less than 80° to no more than 100° from the extending direction of the ridge lines of the unit optical elements 24a of the light guide plate 221. More preferably, the extending direction is deviated by an angle of no less than 85° and no more than 95°. As such, the extending direction of the ridge lines of the unit prisms 232a and the extending direction of the ridge lines of the unit optical elements 24a may be orthogonal to each other, when the display device is seen from the front.

Further, it is preferable that the extending direction of the ridge lines of the unit prisms 232a crosses the transmission axis of the lower polarizing plate 14 of the liquid crystal panel 15, when it is observed from the front. More preferably, the longitudinal direction of the unit prisms 232a of the prism sheet 230 crosses the transmission axis of the lower polarizing plate 14 of the liquid crystal panel 15 at an angle larger than 45° and smaller than 135° on the face parallel to the display face of the display device (the face parallel to the sheet face of the body portion 31 of the prism sheet 230). The angle mentioned here means a smaller angle of the angles made by the longitudinal direction of the unit prisms 232a and the transmission axis of the lower polarizing plate 14, that is, an angle of 180° or less. Particularly in this embodiment, the longitudinal direction of the unit prisms 232a of the prism sheet 230 is preferably orthogonal to the transmission axis of the lower polarizing plate 14 of the liquid crystal panel 15; and the arrangement direction of the unit prisms 232a of the prism sheet 230 is preferably parallel to the transmission axis of the lower polarizing plate 14 of the liquid crystal panel 15.

Next, the cross-sectional shape of the unit prism 232a in the arrangement direction thereof will be described. FIG. 10 is an enlarged view of a part of the prism sheet 230 shown in FIG. 9. In FIG. 10, “n_{d}” shows the normal direction of the sheet face of the body portion 31.

As can be seen from FIG. 10, in this embodiment, the unit prism 232a has an isosceles triangular cross section, projecting to the light guide plate 221 side of the body portion 31. That is, the width of the unit prism 232a in a direction parallel to the sheet face of the body portion 31 gets smaller as it gets farther from the body portion 31 along the normal direction n_{d} of the body portion 31.

In this embodiment, the outer contour of the unit prism 232a forms a line symmetry with an axis parallel to the normal direction n_{d} of the body portion 31 as an symmetrical axis; and the cross section of the unit prism 232a is an isosceles triangle in this embodiment. With this configuration, the brightness on the light output face of the prism sheet 230 can have a symmetrical angle distribution of brightness around the front direction, in the plane parallel to the arrangement direction of the unit prisms 232a.

Here, the size of the unit prism 232a is not particularly limited, and it is preferable that the vertex angle θ₁₀ (see FIG. 10) at the tip of the convex portion of the unit prism 232a is no more than 80°. This makes it possible to obtain a proper light condensing property, with this arrangement structure of the unit prisms 232a that the unit prisms 232a are arranged facing to the light output face of the light guide plate 221. More preferably, the vertex angle θ₁₀ is no less than 60° and no more than 80°. It is also preferable that the value of the width W of the bottom base is the same as the value of the pitch P. The pitch P between the adjacent unit prisms 232a is no less than 10 μm. Other determinations regarding the pitch P will be described later.

In this embodiment, the unit prism having the triangular-shaped cross section as described above has been explained; however, the cross-sectional shape is not limited thereto. It may be a trapezoidal shape, changing the vertex part of the triangle into a shorter upper base. Further, the oblique line of the triangle may be a polygonal line or a curved line. Thus the shape of the cross section may be in a polygonal shape such as a tetragon or a pentagon.

The light diffusing layer 235 is a layer formed of a light transmitting resin layer 36 containing a lot of light diffusing particles 37 which have a refractive index different from that of the light transmitting resin layer 36. Part of the light diffusing particles 37 projects from the surface of the light transmitting resin layer 36, which makes the surface of the light diffusing layer 235 have asperities. The materials configuring the light diffusing layer 235 and the method of forming the layer 235 is the same as that of the light diffusing layer 35.

The surface roughness of the light diffusing layer 235 is no less than 0.038 (μm) by Ra (μm) (JIS B 0601 (2001) arithmetic average roughness), and it satisfies the following formula (3).

Ra≦−0.0208·P+2.0223 (3)

Here, P is the pitch P (μm) of adjacent unit prisms 232a of the unit prism portion 232 described above. That is, Ra in this embodiment is no less than 0.038 μm and at the same time Ra satisfies the above formula (3). The pitch P of the unit prism 232a satisfies the above formula (3) in the range of no less than 10 μm.

If Ra of the light diffusing layer 235 is less than 0.038 μm, the light diffusing layer 235 does not function as a light diffusing layer, and cannot exert a concealing property. If the pitch P of the unit prisms 232a is less than 10 μm, it is not possible to practically obtain a product which can be produced on a large scale, due to the limitations of tools for producing molds, and the limitations of the processing accuracy in molding.

This makes it possible, in a two-lamp type surface light source device having the first lamp side light source and the second lamp side light source, to inhibit scintillations while having a concealing property, and at the same time to inhibit degradation of brightness (obtain a low haze value). Thus, a prism sheet having a good use efficiency of lights, in addition to the effects expected to conventional light diffusing layers, can be obtained.

Here, the haze (total haze) of the prism sheet 230 is dominated from the light diffusing layer 233. By satisfying the above formula (3), it is possible to obtain the above effects, even though the haze of the prism sheet 230 is no more than 50%.

Next, the functions of the liquid crystal display device having the image source unit 210 of the present configuration will be described with an example of the light path. However, the example of the light path is conceptually shown, and does not strictly show the degrees of the reflection and refraction, and the like.

First, the light emitted from the first lamp side light source 26 enters the light guide plate 221 through the light input face on the side face of the light guide plate 221, as shown in FIG. 9. FIG. 9 shows, as one example, light paths of the lights L₉₁ and L₉₂ entered the light guide plate 221 from the first lamp side light source 26.

The lights L₉₁ and L₉₂ that have entered the light guide plate 221 are totally reflected on the face of the unit optical element portion 24 of the light guide plate 221 and on the face of the back face prism portion 223 opposite thereto, due to the refractive index difference from the air; and the light emitted from the back face, which is not shown, is brought back to the light guide plate 221 by the reflection sheet 40. Repeating the above reflections, the lights move toward the second lamp side light source 226, in the extending direction (light guiding direction) of the ridge line of the unit optical element 24a.

On the other hand, the light emitted from the second lamp side light source 226 enters the light guide plate 221 through the light input face on the side face of the light guide plate 221 which is on the opposite side of the first lamp side light source 26, as shown in FIG. 9. FIG. 9 shows an example of the light paths of the lights L₉₃ and L₉₄ entered the light guide plate 221 from the second lamp side light source 226.

The lights L₉₃ and L₉₄ that have entered the light guide plate 221 are totally reflected on the face of the unit optical element portion 24 of the light guide plate 221 and on the face of the back face prism portion 223 opposite thereto, due to the refractive index difference from the air; and the light emitted from the back face, which is not shown, is brought back to the light guide plate 221 by the reflection sheet 40. Repeating the above reflections, the lights move toward the first lamp side light source 26, in the extending direction (light guiding direction) of the ridge line of the unit optical element 24a.

It is noted that the back face prism portion 223 is formed on the back face side of the base portion 22 of the light guide plate 221. Therefore in some cases, as shown in FIG. 9, moving directions of the lights L₉₁, L₉₂, L₉₃ and L₉₄ moving through the light guide plate 221 are changed irregularly by the back face prism portion 223, and thus the lights L₉₁, L₉₂, L₉₃ and L₉₄ enter the unit optical element portion 24 at an incident angle less than a total reflection critical angle. In this case, the lights may be emitted from the unit optical element portion 24 of the light guide plate 221. The lights L₉₁, L₉₂, L₉₃ and L₉₄ emitted from the unit optical element portion 24 move to the prism sheet 230 arranged on the light output side of the light guide plate 221.

This makes the lights moving through the light guide plate 221 exit little by little from the light output face. This enables a uniform light amount distribution, along the light guiding direction, of the light emitted from the unit optical element portion 24 of the light guide plate 221.

Here, the unit optical element portion 24 of the light guide plate 221 functions in the same way as described above. Therefore, the unit optical element portion 24 exerts a light condensing effect on the light component along the direction orthogonal to the light guiding direction. The emission angle of the light emitted from the light guide plate 221 is concentrated into a narrow angle range around the front direction, in the plane parallel to the arrangement direction of the unit optical element 24a of the light guide plate 221.

The light emitted from the light guide plate 221 thereafter enters the prism sheet 230. The unit prism 232a of the prism sheet 230, like the unit optical element 24a of the light guide plate 221, exerts a light condensing effect on the transmitted light by the refraction and total reflection on the light input face of the unit prism 232a. However, the light whose moving direction is changed in the prism sheet 230 is a component in the plane of the prism sheet 230 orthogonal to the arrangement direction of the unit prisms 232a; and is different from the light component concentrated in the light guide plate 221. That is, as shown by L₁₀₁ in FIG. 10, the light that has entered the unit prism 232a is totally reflected at the interface between the unit prism 232a and the air, based on the refractive index difference between them. At this time, the oblique line of the unit prism 232a is inclined at θ₁₀/2 against the normal line n_{d} to the sheet face; therefore the reflected light at the interface has an angle closer to the normal line n_{d} than the incident light.

That is, in the light guide plate 221, the moving direction of the light is concentrated into the narrow angle range around the front direction, in the plane parallel to the arrangement direction of the unit optical elements 24a of the light guide plate 221. On the other hand, in the prism sheet 230, the moving direction of the light is concentrated into the narrow angle range around the front direction, in the plane parallel to the arrangement direction of the unit prisms 232a of the prism sheet 230. Therefore, it is possible, by the optical effects exerted in the prism sheet 230, to further enhance the front direction brightness without degrading the front direction brightness already enhanced in the light guide plate 221.

The light L₁₀₁ totally reflected by the unit prism 232a transmits the body portion 31 and is diffused at the light diffusing layer 235, to be emitted from the prism sheet 230. At this time, the degradation of brightness is inhibited. Therefore, as described above, it is possible to emit the light having a high front brightness whose direction is changed by the unit prism 232a, with an efficient light brightness. In addition, the concealing property is sufficiently secured since the image clarity is kept low. Scintillation is also inhibited by the prism sheet 230.

The light emitted from the prism sheet 230 enters the lower polarizing plate 14 of the liquid crystal panel 15. Of the incident light, the lower polarizing plate 14 transmits one of the polarization components and absorbs the other polarization component. The light transmitted through the lower polarizing plate 14 selectively passes through the upper polarizing plate 13 in accordance with the state of the application of the electric field on each pixel. In this manner, the liquid crystal panel 15 selectively transmits the light from the surface light source device 220 on a pixel to pixel basis, thereby enabling the observer of the liquid crystal display device to observe the image.

Various applications can be considered of the liquid crystal display device having the image source unit of each configuration described above. Examples thereof include liquid crystal displays, televisions, portable terminals, car navigations, electronic blackboards, and electronic advertising boards.

Further, from the view point that the surface light source device can increase the use efficiency of lights and can inhibit scintillations, the surface light source device can exert its function even when used as lighting. That is, the surface light source device can be applied to lighting equipments such as ceiling lights and stand type lights.

### EXAMPLES

### Example 1

Example 1 is an example regarding the first embodiment described above, that is, an example relating to the formula (1). In Example 1, prism sheets each having a different size of the unit prism, pitch, and surface roughness (Ra) of the light diffusing layer were prepared and compared. Followings are the conditions and results.

<Body Portion>

A PET film (A4300 manufactured by TOYOBO CO., LTD.) having a thickness of 125 μm was used for the body portion of each specimen.

<Unit Prism Portion>

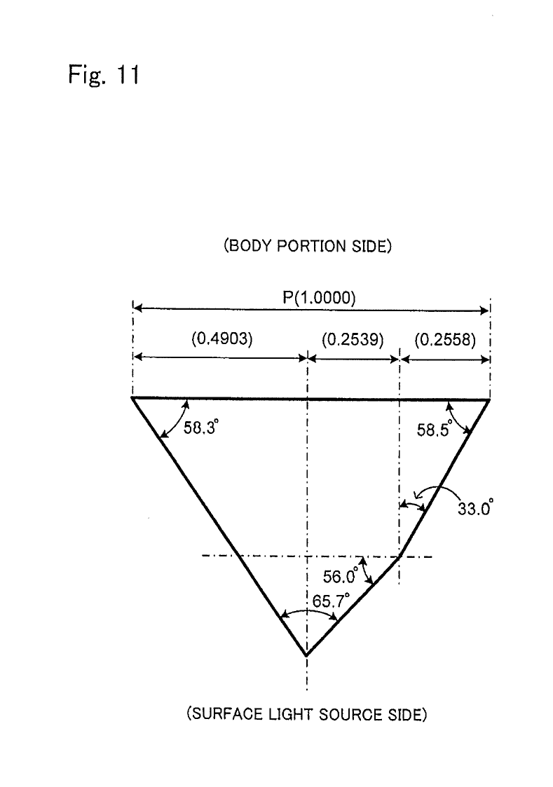

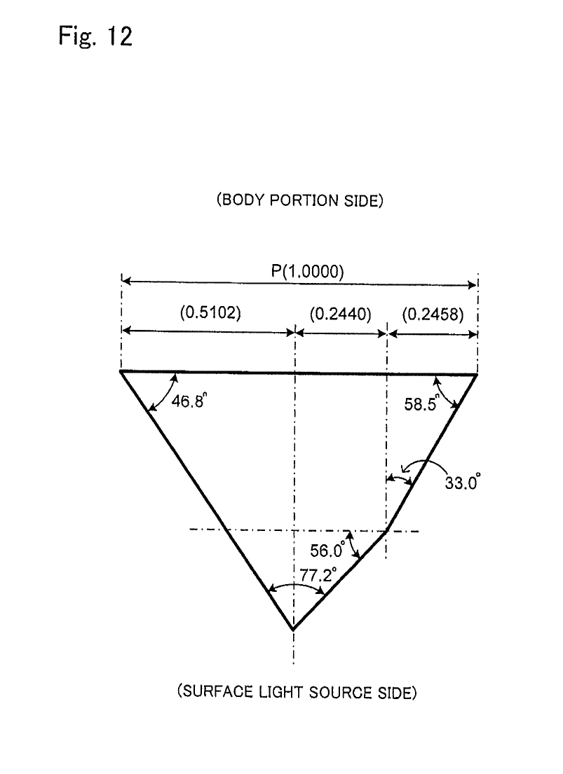

On one face of the body portion, a unit prism portion formed of an ultraviolet curable resin (RC25-750, manufactured by DIC CORPORATION), where unit prisms each having a cross sectional in the shape of a tetragon shown in FIGS. 11 and 12 were allayed, was shaped.

Specimens 1 to 15 each having the shape of the unit prism shown in FIG. 11 were produced. In this embodiment, four different pitches P were prepared. The unit prisms each having four different pitches had a size in the direction of the pitch P distributed at the ratio shown in parentheses in FIG. 11, and formed having fixed angles. The pitch P had four kinds of 18 μm, 34 μm, 54.5 μm, and 64 μm.

The specimens 16 and 17 were produced having the shape of the unit prism shown in FIG. 12. In this embodiment, the pitch P was 18 μm, the size of the unit prism in the direction of the pitch P was distributed at the ratio shown in parentheses in FIG. 12, and the angles were as shown in FIG. 12.

<Light Diffusing Layer>

The following compositions were prepared for forming the light diffusing layer. Each light diffusing layer was formed by: applying, by a coater, a resin (ink) to be a light transmitting resin layer, where light diffusing particles were dispersed, to a face of the body portion, the face to be the opposite side of the unit prism portion; and curing it. The structure of each light diffusing layer is as follows. Here, pentaerythritol triacrylate (refractive index 1.51) was used for the resin (light transmitting resin, binder) of the light transmitting resin layer of each composition.

### (1) Composition 1

light diffusing particles/light transmitting resin (mass ratio): 7/100

light diffusing particle: made of styrene resin, average particle size 2 μm (refractive index 1.59)

(the average particle size was obtained by a laser diffraction type particle size distribution measurement method. The same was applied hereinafter.)

coating thickness: 3 μm

### (2) Composition 2

light diffusing particles/light transmitting resin (mass ratio): 7/100

light diffusing particle A: made of styrene resin, average particle size 2 μm (refractive index 1.59)

light diffusing particle B: made of acrylic resin, average particle size 5 μm (refractive index 1.49)

light diffusing particle A/light diffusing particle B (mass ratio): 8.5/1.5

coating thickness: 3 μm

### (3) Composition 3

light diffusing particles/light transmitting resin (mass ratio): 10/100

light diffusing particle: made of acrylic resin, average particle size 5 μm (refractive index 1.49)

coating thickness: 3 μm

### (4) Composition 4

light diffusing particles/light transmitting resin (mass ratio): 8/100

light diffusing particle: made of styrene resin, average particle size 3.5 μm (refractive index 1.59)

coating thickness: 1.5 μm

### (5) Composition 5

light diffusing particles/light transmitting resin (mass ratio): 15/100

light diffusing particle: made of urethane resin, average particle size 6 μm (refractive index 1.43), polydisperse

coating thickness: 3 μm

### (6) Composition 6

light diffusing particles/light transmitting resin (mass ratio): 9/100

light diffusing particle: made of acrylic resin, average particle size 5 μm (refractive index 1.49)

coating thickness: 3 μm

### (7) Composition 7

light diffusing particles/light transmitting resin (mass ratio): 7/100

light diffusing particle A: made of styrene resin, average particle size 2 μm (refractive index 1.59)

light diffusing particle B: made of acrylic resin, average particle size 5 μm (refractive index 1.49)

light diffusing particle A/light diffusing particle B (mass ratio): 9.0/1.0

coating thickness: 3 μm

### (8) Composition 8

light diffusing particles/light transmitting resin (mass ratio): 4/100

light diffusing particle: made of acrylic resin, average particle size 5 μm (refractive index 1.49)

coating thickness: 3 μm

### (9) Composition 9

light diffusing particles/light transmitting resin (mass ratio): 7/100

light diffusing particle: made of styrene resin, average particle size 2 μm (refractive index 1.59)

coating thickness: 1.5 μm

### (10) Composition 10

light diffusing particles/light transmitting resin (mass ratio): 20/100

light diffusing particle: made of urethane resin, average particle size 6 μm (refractive index 1.43), polydisperse

coating thickness: 3 μm

Each specimen was formed with the conditions shown in Table 1. Specimen 11 was an example where the light diffusion layer was not formed, and only the body portion and the unit prism portion were formed. Evaluated for each specimen were the haze (total haze, inner haze, and outer haze), brightness ratio, surface roughness, scintillation index, visual judgment of scintillations, and visual judgment of concealing property. The results are together shown in Table 1. Details of each evaluation are as follows.

Table 1 also shows whether each specimen satisfied the above formula (1) or not. “o” means the specimen satisfied the formula 1, and “x” means the specimen did not satisfy the formula (1).

<Haze Measurement>

Haze measurement was carried out by means of HM150 manufactured by MURAKAMI COLOR RESEARCH LABORATORY, in accordance with JIS K 7105. The measurement value was determined as the total haze (haze). After the measurement of this haze, the resin used for the light transmitting resin layer except the light diffusing particles was prepared as an ink, and further applied to the light diffusing layer. The light diffusing particles were all buried by the light transmitting resin, and the above haze measurement was carried out thereto. The measurement value was determined as the inner haze. The difference between the haze and the inner haze was determined as the outer haze.

<Brightness Ratio Measurement>

The brightness ratio was shown by the ratio of the brightness of each specimen to the brightness of specimen 11. The brightness was measured from 50 cm directly above the specimen, at 1° of solid angle, by means of BM-7 manufactured by TOPCON CORPORATION. Specimen 11 was considered as an example which had the highest brightness, since it did not have the light diffusing layer.

<Surface Roughness>

The surface roughness was determined by measuring the arithmetic average roughness Ra in accordance with JIS B 0601 (2001). The measurement was carried out by Surfcorder SE1700α manufactured by Kosaka Laboratory Ltd.

<Calculation of Scintillation Index>

On the light output side of a light source (white LED) and a light guide plate (the above-described light guide plate 21), each specimen was arranged. On the light output side of the specimen, the above-described liquid crystal panel (TN crystal liquid, 13.3 inch FHD) was arranged. Measurements was carried Out to the output face of the liquid crystal panel with the light source on, thereby the deviation of color temperatures in the face, and the average value of the color temperatures in the face were obtained. More specifically, 2.31 mm×2.31 mm of the output face of the liquid crystal panel was divided into 50×50 (2500 pixels), and the color temperature of each pixel was measured by means of a chromaticity measurement device (ProMetric, manufactured by CYBERNET SYSTEMS CO., LTD.). From the obtained deviation and average value of the color temperatures, the scintillation index was calculated with the following formula (10).

Scintillation index=deviation of the color temperatures/average value of color temperatures (10)

Here, the inventors of the present invention were found that scintillations did not occur when the scintillation index was less than 0.110.

<Visual Evaluation of Scintillation and Concealing Property>

The scintillation and concealing property were visually observed and evaluated in a conventional way. As for the scintillation, “⊚” was given to the specimen where scintillations did not occur, “∘” was given to the specimen where scintillations occurred but in an acceptable range, and “x” was given to the specimen where scintillations unacceptably occurred. On the other hand, as for the concealing property, “⊚” was given to the specimen where any shining belt in rainbow color (rainbow unevenness) was not seen at all, when the prism sheet was arranged on the light source and observed from the left, light, top, and bottom thereof in a range of ±45° from the front by transmission observation; “∘” was given to the specimen where the rainbow unevenness was seen but in an acceptable range; and “x” was given to the specimen where the rainbow unevenness was unacceptably seen.

TABLE 1

| | | | | | | | | | | | | Satis- |
|---|---|---|---|---|---|---|---|---|---|---|---|---|
| | Composition of | Shape | Pitch of | | Inner | Outer | Bright- | | Scintil- | | Concealing | faction |
| | Light Diffusing | of Unit | Unit Prism | Haze | Haze | Haze | ness | Ra | lation | Scintialltion | Property | of Formula |
| | Layer | Prism | (μm) | (%) | (%) | (%) | Ratio(%) | (μm) | Index | (Visual) | (Visual) | (1) |
| Specimen 1 | Composition 1 | FIG. 11 | 18 | 20.2 | 17.5 | 2.7 | 92 | 0.0580 | 0.0952 | ◯ | ◯ | ◯ |
| Specimen 2 | Composition 2 | FIG. 11 | 18 | 20.1 | 13.4 | 6.7 | 94 | 0.3478 | 0.1042 | ◯ | ◯ | ◯ |
| Specimen 3 | Composition 3 | FIG. 11 | 18 | 30.0 | 1.1 | 28.9 | 96 | 1.1220 | 0.1078 | ◯ | ◯ | ◯ |
| Specimen 4 | Composition 1 | FIG. 11 | 34 | 20.2 | 17.5 | 2.7 | 92 | 0.0580 | 0.1062 | ◯ | ◯ | ◯ |
| Specimen 5 | Composition 2 | FIG. 11 | 34 | 20.1 | 13.4 | 6.7 | 94 | 0.3478 | 0.1079 | ◯ | ◯ | ◯ |
| Specimen 6 | Composition 4 | FIG. 11 | 34 | 23.9 | 10.9 | 13.0 | 91 | 0.4257 | 0.1088 | ◯ | ◯ | ◯ |
| Specimen 7 | Composition 1 | FIG. 11 | 54.5 | 20.2 | 17.5 | 2.7 | 92 | 0.0580 | 0.1076 | ◯ | ◯ | ◯ |
| Specimen 8 | Composition 5 | FIG. 11 | 18 | 42.2 | 1.5 | 40.7 | 91 | 1.4030 | 0.1096 | ◯ | ◯ | ◯ |
| Specimen 9 | Composition 6 | FIG. 11 | 34 | 27.4 | 0.8 | 26.6 | 97 | 0.9362 | 0.1098 | ◯ | ◯ | ◯ |
| Specimen 10 | Composition 7 | FIG. 11 | 54.5 | 20.2 | 14.9 | 5.3 | 94 | 0.3121 | 0.1096 | ◯ | ◯ | ◯ |
| Specimen 11 | — | FIG. 11 | 18 | 0.2 | — | — | 100 | 0.0210 | 0.0898 | ⊚ | X | X |
| Specimen 12 | Composition 10 | FIG. 11 | 18 | 66.0 | 1.7 | 64.3 | 85 | 1.5730 | 0.1218 | X | ⊚ | X |
| Specimen 13 | Composition 3 | FIG. 11 | 34 | 30.0 | 1.1 | 28.9 | 96 | 1.1220 | 0.1178 | X | ◯ | X |
| Specimen 14 | Composition 8 | FIG. 11 | 54.5 | 10.0 | 0.9 | 9.1 | 99 | 0.5380 | 0.1154 | X | ◯ | X |
| Specimen 15 | Composition 9 | FIG. 11 | 64 | 20.2 | 10.2 | 10.0 | 92 | 0.1320 | 0.1122 | X | ◯ | X |
| Specimen 16 | Composition 3 | FIG. 12 | 18 | 30.0 | 1.1 | 28.9 | 96 | 1.1220 | 0.1081 | ◯ | ◯ | ◯ |
| Specimen 17 | Composition 10 | FIG. 12 | 18 | 66.0 | 1.7 | 64.3 | 85 | 1.5730 | 0.1222 | X | ⊚ | X |

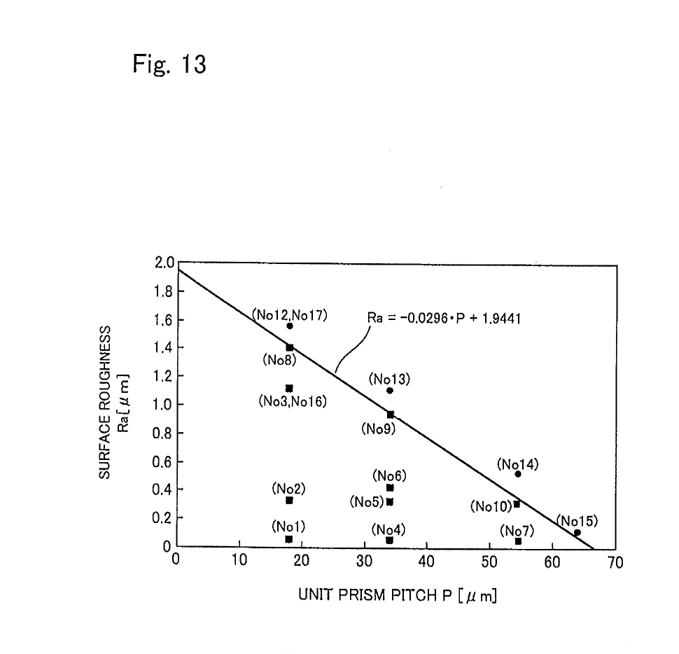

FIG. 13 shows a graph where the pitch P (μm) of the unit prism was taken along the horizontal axis, and the surface roughness Ra was taken along the vertical axis, for specimens 1 to 10 and specimens 12 to 17. FIG. 13 also shows the following formula (11) where the right-hand side of the formula (1) is equal to the left-hand side of the formula (1).

Ra=−0.0296·P+1.9441 (11)

The number of each specimen was shown with “No” near each plot of FIG. 13.

Here, the formula (11) was obtained as follows. That is, for each pitch P, based on the examples where the scintillation index was less than 0.100 and closest to 0.110 (in this Examples, specimens 8, 9 and 10) and the examples where the scintillation index was more than 0.110 and closest to 0.110 (in this Example, specimens 12, 13 and 14), the surface roughness Ra where the scintillation index was 0.110 for each pitch P was calculated by a ratio calculation (step 1). From the result, a linear approximation was carried out by a least-squares method, to obtain the formula (11) (step 2). More details are shown below. Each of steps 1 and 2 will be explained.

(Step 1)

In the step 1, for each pitch P, the surface roughness Ra where the scintillation index was 0.110 was calculated by a ratio calculation. That is, regarding a pitch P, the surface roughness Rₐ where scintillation index was 0.110 was able to be obtained from the following formula (12):

Ra₁+{(Ra₂−Ra₁)/(G₂−G₁)}×(0.110−G₁) (12)

wherein G₁ was the scintillation index of the specimen having a scintillation index less than 0.110, Ra₁ was the surface roughness Rₐ of the specimen having a scintillation index less than 0.110, G₂ was the scintillation index of the specimen having a scintillation index larger than 0.110, Ra₂ was the surface roughness Rₐ of the specimen having a scintillation index larger than 0.110.

In this example, the pitch P had three kinds of 18.0 μm, 34.0 μm, and 54.5 μm. Thus, for each pitch P, the surface roughness Ra where the scintillation index was 0.110 was calculated by the formula (12).

As an example, a case where the pitch P was 18.0 μm is considered here. Specimens 8 and 12 have the pitch P of 18.0 μm. Each surface roughness Ra was 1.403 μm (Ra₁), and 1.573 μm (Ra₂). Each scintillation index was 0.1096 (G₁), and 0.1218 (G₂). With these data, the following formula (13) was obtained from the formula (12), to obtain the surface roughness Ra where the pitch P was 18 μm and the scintillation index was 0.110.

1.403+{(1.573−1.403)/(0.1218−0.1096)}×(0.110−0.1096)=1.4085738 (13)

For other pitches P, the surface roughness where the scintillation index was 0.110 was obtained from the formula (12) in accordance with the above description. Table 2 shows the results.

TABLE 2

| P (μm) | Ra (μm) |
|---|---|
| 18 | 1.4085738 |
| 34 | 0.9408450 |
| 54.5 | 0.3276793 |

(Step 2)

Next, using the three points in Table 2 obtained by the step 1, a linear approximate expression was obtained by a least-squares method. This linear approximate expression was f(x)=ax+b wherein a was a coefficient and b was a y intercept, and a and b were able to be obtained from the following formulas (14) and (15), respectively.

$$\begin{matrix}[ Formula 1 ] & \\ a = \frac{n {\sum }_{k = 1}^{n} {x}_{k} {y}_{k} - {\sum }_{k = 1}^{n} {x}_{k} {\sum }_{k = 1}^{n} {y}_{k}}{n {\sum }_{k = 1}^{n} {x}_{k}^{2} - {( {\sum }_{k = 1}^{n} {x}_{k} )}^{2}} & ( 14 ) \\ b = \frac{{\sum }_{k = 1}^{n} {x}_{k}^{2} {\sum }_{k = 1}^{n} {y}_{k} - {\sum }_{k = 1}^{n} {x}_{k} {y}_{k} {\sum }_{k = 1}^{n} {x}_{k}}{n {\sum }_{k = 1}^{n} {x}_{k}^{2} - {( {\sum }_{k = 1}^{n} {x}_{k} )}^{2}} & ( 15 )\end{matrix}$$

Here n=3, the pitch P was able to be applied to x, and the surface roughness Ra was able to be applied to y. Thereby, the formulas (14) and (15) specifically became like the formulas (16) and (17), and specific values were able to be obtained.

$$\begin{matrix}[ Formula 2 ] & \\ a = \frac{225.605 - 285.111}{13350.8 - 11342.3} = - 0.0296 & ( 16 ) \\ b = \frac{11913.8 - 8008.97}{13350.8 - 11342.3} = 1.9441 & ( 17 )\end{matrix}$$

As is obvious from the above, the formula (1) was able to be obtained.

As can be seen from the above, by satisfying the formula (1), it was possible to inhibit scintillations while securing a concealing property, and inhibit the degradation of brightness.

### Example 2

Example 2 is an example regarding the second embodiment, that is, an example relating to the formula (2). In Example 2, prism sheets each having a different shape of the unit prism, pitch, and surface roughness (Ra) of the light diffusing layer were prepared and compared. The conditions and results are shown below.

<Body Portion>

A PET film (A4300 manufactured by TOYOBO CO., LTD.) having a thickness of 125 μm was used for each body portion of the specimens.

<Unit Prism Portion>

On one face of the body portion, a unit prism portion formed by an ultraviolet curable resin (RC25-750 manufactured by DIC CORPORATION, refractive index after curing 1.51), where unit prisms each having a cross sectional shape shown in FIG. 8 were allayed, was shaped. Four different pitches P were prepared. The specific shape of the unit prism is shown below with signs in FIG. 8.

θ₇=75°

θ₈₁=174°

θ₈₂=173°

VIIIa=0.5338

VIIIb=0.1111

VIIIc=0.1388

VIIId=0.2162

The pitch P had four kinds of 18 μm, 34 μm, 54.5 μm, and 64 μm.

<Light Diffusing Layer>

The following compositions were prepared for forming the light diffusing layers. Each light diffusing layer was formed by: applying, by a coater, a resin (ink) to be a light transmitting resin layer, where light diffusing particles were dispersed, to a face of the body portion, the face to be the opposite side of the unit prism portion; and curing it. The structure of each light diffusing layer is as follows. Here, pentaerythritol triacrylate (refractive index 1.51) was used for the resin (light transmitting resin, binder) of the light transmitting resin layer of each composition.

### (1) Composition 11

light diffusing particles/light transmitting resin (mass ratio): 20/100

light diffusing particle: made of urethane resin, average particle size 6 μm, polydisperse (refractive index 1.51, Art-pearl (registered trademark) C-800 transparent, manufactured by Negami Chemical Industrial Co., Ltd.)

coating thickness: 3 μm

### (2) Composition 12

light diffusing particles/light transmitting resin (mass ratio): 10/100

light diffusing particle: made of acrylic resin, average particle size 5 μm, (refractive index 1.49, Techpolymer (registered trademark) SSX-105, manufactured by SEKISUI PLASTICS CO., LTD.)

coating thickness: 3 μm

### (3) Composition 13

light diffusing particles/light transmitting resin (mass ratio): 4/100

light diffusing particle: made of acrylic resin, average particle size 5 μm, (refractive index 1.49, Techpolymer (registered trademark) SSX-105, manufactured by SEKISUI PLASTICS CO., LTD.)

coating thickness: 3 μm

### (4) Composition 14

light diffusing particles/light transmitting resin (mass ratio): 7/100

light diffusing particle A: made of styrene resin, average particle size 2 μm, (refractive index 1.59, Techpolymer (registered trademark) SSX-302ABE, manufactured by SEKISUI PLASTICS CO., LTD.)

light diffusing particle B: made of acrylic resin, average particle size 5 μm, (refractive index 1.49, Techpolymer (registered trademark) SSX-105, manufactured by SEKISUI PLASTICS CO., LTD.)

light diffusing particle A/light diffusing particle B (mass ratio): 8.5/1.5

coating thickness: 3 μm

### (5) Composition 15

light diffusing particles/light transmitting resin (mass ratio): 9/100

light diffusing particle: made of acrylic resin, average particle size 10 μm, (refractive index 1.49, Techpolymer (registered trademark) SSX-110, manufactured by SEKISUI PLASTICS CO., LTD.)

coating thickness: 3 μm

### (6) Composition 16

light diffusing particles/light transmitting resin (mass ratio): 9/100

light diffusing particle: made of acrylic resin, average particle size 8 μm, (refractive index 1.49, Techpolymer (registered trademark) SSX-108, manufactured by SEKISUI PLASTICS CO., LTD.)

coating thickness: 3 μm

### (7) Composition 17

light diffusing particles/light transmitting resin (mass ratio): 9/100

light diffusing particle: made of acrylic resin, average particle size 5 μm, (refractive index 1.49, Techpolymer (registered trademark) SSX-105, manufactured by SEKISUI PLASTICS CO., LTD.)

coating thickness: 3 μm

Each specimen was formed with the conditions shown in Table 3.

For specimens 21 to 28, the above-described unit prism based on FIG. 8 was applied.

Specimen 29 was an example where the light diffusion layer was not formed, and only the body portion and the unit prism portion by the above-described unit prism based on FIG. 8 were formed.

Evaluated for each specimen were the haze (total haze, inner haze, and outer haze), brightness ratio, surface roughness, scintillation index, visual judgment of scintillations, and visual judgment of concealing property. The results are together shown in Table 3. Details of each evaluation and evaluation criteria were same as in Example 1.

TABLE 3

| | | | | | | | | | | | | Satis- |
|---|---|---|---|---|---|---|---|---|---|---|---|---|
| | Composition of | Shape | Pitch of | | Inner | Outer | Bright- | | Scintil- | Scintil- | Concealing | faction |
| | Light Diffusing | of Unit | Unit Prism | Haze | Haze | Haze | ness | Ra | lation | lation | Property | of Formula |
| | Layer | Prism | (μm) | (%) | (%) | (%) | Ratio(%) | (μm) | Index | (Visual) | (Visual) | (2) |
| Specimen 21 | Composition 11 | FIG. 8 | 18 | 66.0 | 1.7 | 64.3 | 85 | 1.5730 | 0.1095 | ◯ | ⊚ | ◯ |
| Specimen 22 | Composition 12 | FIG. 8 | 34 | 30.0 | 1.1 | 28.9 | 96 | 1.1220 | 0.1086 | ◯ | ◯ | ◯ |
| Specimen 23 | Composition 13 | FIG. 8 | 54.5 | 10.0 | 0.9 | 9.1 | 99 | 0.5380 | 0.1093 | ◯ | ◯ | ◯ |
| Specimen 24 | Composition 14 | FIG. 8 | 64 | 20.1 | 13.4 | 6.7 | 94 | 0.3478 | 0.1082 | ◯ | ◯ | ◯ |
| Specimen 25 | Composition 15 | FIG. 8 | 18 | 27.6 | 1.0 | 26.6 | 94 | 1.8420 | 0.1165 | X | ◯ | X |
| Specimen 26 | Composition 16 | FIG. 8 | 34 | 26.3 | 1.0 | 25.3 | 95 | 1.4210 | 0.1201 | X | ◯ | X |
| Specimen 27 | Composition 17 | FIG. 8 | 54.5 | 27.4 | 0.8 | 26.6 | 97 | 0.9362 | 0.1189 | X | ◯ | X |
| Specimen 28 | Composition 13 | FIG. 8 | 64 | 10.0 | 0.9 | 9.1 | 99 | 0.5380 | 0.1134 | X | ◯ | X |
| Specimen 29 | — | FIG. 8 | 18 | 0.2 | — | — | 100 | 0.0210 | 0.0821 | ⊚ | X | X |

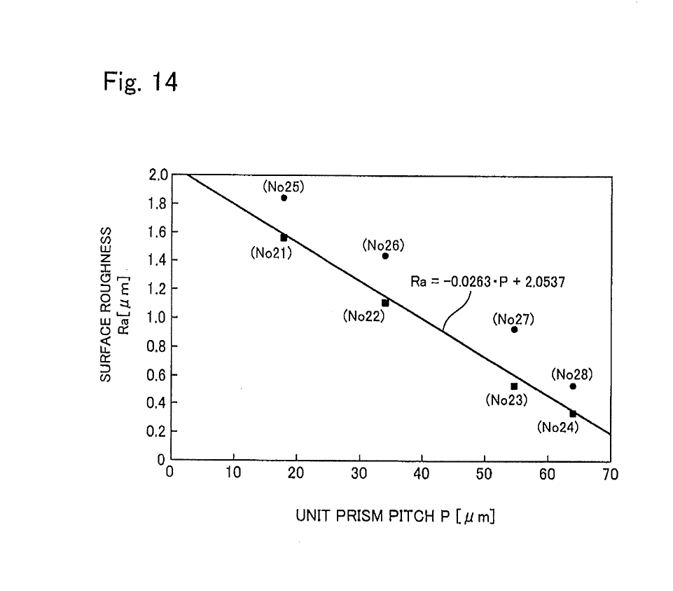

FIG. 14 shows a graph where the pitch P (μm) of the unit prism was taken along the horizontal axis, and the surface roughness Ra (μm) was taken along the vertical axis, regarding specimens 21 to 28. FIG. 14 also shows the following formula (18) where the right-hand side of the formula (2) is equal to the left-hand side of the formula (2).

Ra=−0.0263·P+2.0537 (18)

The number of each specimen was shown with “No” near each plot of FIG. 14. The formula (18) was obtained based on the results of specimens 21 to 28, in the same way as the deriving way of the formula (11) in Example 1.

Specimens 21 to 24 had good results of the visual judgments of scintillations and concealing property. The scintillation indexes thereof were no less than 0.108 and no more than 0.110. On the other hand, specimens 25 to 28 did not satisfy the requirements regarding the scintillation, even though the same unit prism (FIG. 8) as specimens 21 to 24 was used.

As can be seen from the above, it was possible to inhibit scintillations while securing a concealing property, and inhibit the degradation of use efficiency of lights, by satisfying the formula (2).

### Example 3

Example 3 is an example regarding the above-described third embodiment, that is, an example relating to the formula (3). In Example 3, prism sheets each having a different shape of the unit prism, pitch, and the surface roughness (Ra) of the light diffusing layer were prepared and compared. The conditions and results are shown below.

<Body Portion>

A PET film (A4300 manufactured by TOYOBO CO., LTD.) having a thickness of 125 μm was used for each body portion of the specimens.

<Unit Prism Portion>

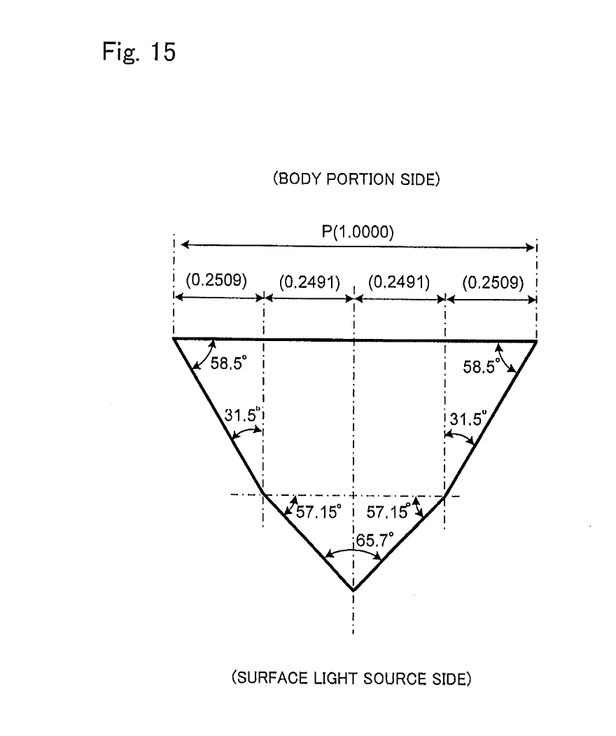

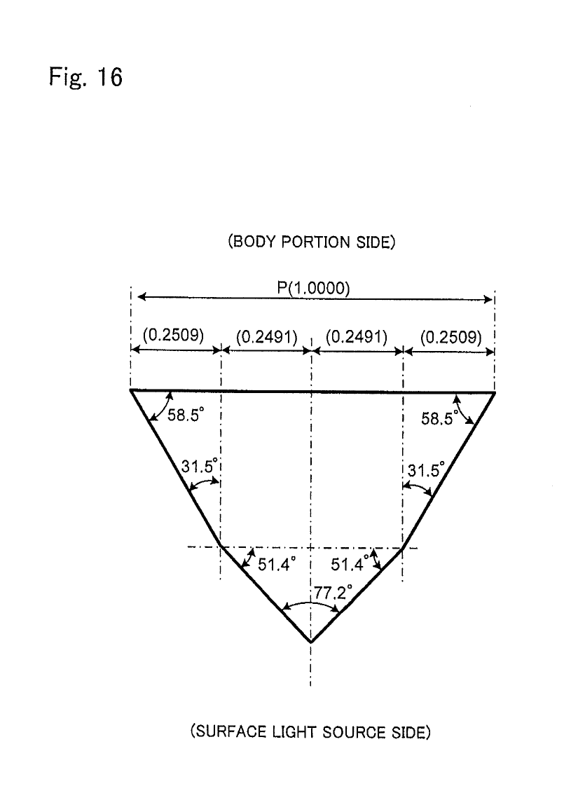

On one face of the body portion, a unit prism portion formed by an ultraviolet curable resin (RC25-750 manufactured by DIC CORPORATION), where unit prisms each having a cross section in the shape of a line-symmetric pentagon shown in FIGS. 15 and 16 were allayed, was shaped.

Specimens 31 to 40 were produced having the shape of the unit prism shown in FIG. 15. In this embodiment, four different pitches P were prepared. The unit prisms having four different pitches had a size in the direction of the pitch P distributed at the ratio shown in parentheses in FIG. 15, and had fixed angles. The pitch P had four kinds of 34 μm, 50 μm, 64 μm, and 75 μm.

With the shape of the unit prism shown in FIG. 16, specimens 41 and 42 were produced. In this embodiment, the pitch P was 34 μm, the size of the unit prism in the direction of the pitch P was divided at the ratio shown in parentheses in FIG. 16, and the angles were as shown in FIG. 16.

<Light Diffusing Layer>

The following compositions were prepared for forming the light diffusing layers. Each light diffusing layer was formed by: applying, by a coater, a resin (ink) to be a light transmitting resin layer, where light diffusing particles were dispersed, to a face of the body portion, the face to be the opposite side of the unit prism portion; and curing it. The structure of each light diffusing layer was as follows. Here, pentaerythritol triacrylate (refractive index 1.51) was used for the resin (light transmitting resin, binder) of the light transmitting resin layer of each composition.

### (1) Composition 21

light diffusing particles/light transmitting resin (mass ratio): 10/100

light diffusing particle: made of acrylic resin, average particle size 5 μm (refractive index 1.49)

(the average particle size was obtained by a laser diffraction particle size distribution measuring method, the same is applied hereinafter)

coating thickness: 3 μm

### (2) Composition 22

light diffusing particles/light transmitting resin (mass ratio): 15/100

light diffusing particle: made of acrylic resin, average particle size 5 μm (refractive index 1.49)

coating thickness: 3 μm

### (3) Composition 23

light diffusing particles/light transmitting resin (mass ratio): 8/100

light diffusing particle: made of acrylic resin, average particle size 5 μm (refractive index 1.49)

coating thickness: 3 μm

### (4) Composition 24

light diffusing particles/light transmitting resin (mass ratio): 9/100

light diffusing particle: made of styrene resin, average particle size 2 μm (refractive index 1.59)

coating thickness: 1.5 μm

### (5) Composition 25

light diffusing particles/light transmitting resin (mass ratio): 7/100

light diffusing particle: made of styrene resin, average particle size 2 μm (refractive index 1.59)

coating thickness: 1.5 μm

### (6) Composition 26

light diffusing particles/light transmitting resin (mass ratio): 8/100

light diffusing particle: made of styrene resin, average particle size 3.5 μm (refractive index 1.59)

coating thickness: 1.5 μm

### (7) Composition 27

light diffusing particles/light transmitting resin (mass ratio): 20/100

light diffusing particle: made of urethane resin, average particle size 6 μm (refractive index 1.43), polydisperse

coating thickness: 3 μm

Each specimen was formed with the conditions shown in Table 4. Specimen 37 was an example where the light diffusing layer was not formed, and only the body portion and the unit prism portion were formed. The same evaluation as in Example 1 was carried out for each specimen. It is noted that, in this Example, lighting by the two-lamp type light source (see FIG. 9) was carried out.

TABLE 4

| | | | | | | | | | | | | Satis- |
|---|---|---|---|---|---|---|---|---|---|---|---|---|
| | Composition of | Shape | Pitch of | | Inner | Outer | Bright- | | Scintil- | Scintil- | Concealing | faction |
| | Light Diffusing | of Unit | Unit Prism | Haze | Haze | Haze | ness | Ra | lation | lation | Property | of Formula |
| | Layer | Prism | (μm) | (%) | (%) | (%) | Ratio(%) | (μm) | Index | (Visual) | (Visual) | (3) |
| Specimen 31 | Composition 21 | FIG. 15 | 34 | 30.0 | 1.2 | 28.8 | 95 | 1.122 | 0.1066 | ◯ | ◯ | ◯ |
| Specimen 32 | Composition 22 | FIG. 15 | 34 | 48.0 | 1.4 | 46.6 | 91 | 1.302 | 0.1093 | ◯ | ◯ | ◯ |
| Specimen 33 | Composition 23 | FIG. 15 | 50 | 25.0 | 0.9 | 24.1 | 97 | 0.768 | 0.1045 | ◯ | ◯ | ◯ |
| Specimen 34 | Composition 24 | FIG. 15 | 50 | 27.4 | 0.8 | 26.6 | 96 | 0.936 | 0.1089 | ◯ | ◯ | ◯ |
| Specimen 35 | Composition 25 | FIG. 15 | 75 | 20.2 | 10.2 | 10.0 | 92 | 0.132 | 0.1024 | ◯ | ◯ | ◯ |
| Specimen 36 | Composition 26 | FIG. 15 | 75 | 23.9 | 10.9 | 13.0 | 91 | 0.426 | 0.1086 | ◯ | ◯ | ◯ |
| Specimen 37 | — | FIG. 15 | 34 | 0.2 | — | — | 100 | 0.021 | 0.0872 | ⊚ | X | X |
| Specimen 38 | Composition 27 | FIG. 15 | 34 | 66.0 | 1.7 | 64.3 | 85 | 1.573 | 0.1178 | X | ⊚ | X |
| Specimen 39 | Composition 21 | FIG. 15 | 50 | 30.0 | 1.2 | 28.8 | 95 | 1.122 | 0.1154 | X | ◯ | X |
| Specimen 40 | Composition 23 | FIG. 15 | 64 | 25.0 | 0.9 | 24.1 | 97 | 0.768 | 0.1122 | X | ◯ | X |
| Specimen 41 | Composition 22 | FIG. 16 | 34 | 48.0 | 1.4 | 46.6 | 91 | 1.302 | 0.1089 | ◯ | ◯ | ◯ |
| Specimen 42 | Composition 27 | FIG. 16 | 34 | 66.0 | 1.7 | 64.3 | 85 | 1.573 | 0.1174 | X | ⊚ | X |

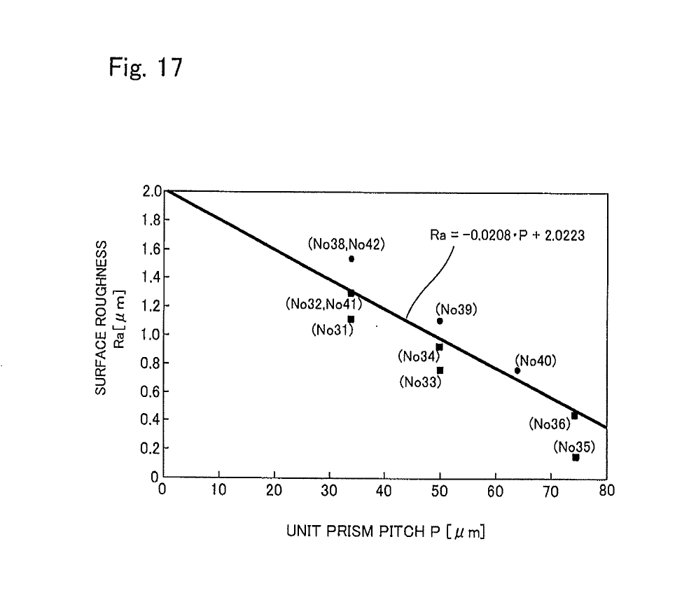

FIG. 17 shows a graph where the pitch P (μm) of the unit prism was taken along the horizontal axis, and the surface roughness Ra (μm) was taken along the vertical axis, regarding specimens 31 to 36 and specimens 38 to 42. FIG. 17 also shows the following formula (19) where the right-hand side of the formula (3) is equal to the left-hand side of the formula (3).

Ra=−0.0208·P+2.0223 (19)

The number of each specimen was shown with “No” near each plot of FIG. 17. The formula (19) was obtained based on the results of specimens 32, 34, 36, 38, 39, and 40 in the same way as the deriving way of the formula (11) in Example 1. However, because the pitches P of specimens 36 and 40 were different, the pitch P where the scintillation index was 0.110 for specimens 36 and 40 were calculated by a ratio calculation, and the calculated pitch was used in an approximate expression calculation by a least-squares method. That is, a surface roughness Ra was obtained by the following formula (20):

P₁+{(P₂−P₁)/(G₂−G₁)}×(0.110−G₁) (20)

wherein G₁ was the scintillation index of a specimen where the scintillation index was less than 0.110, P₁ was the pitch P of the specimen where the scintillation index was less than 0.110, G₂ was the scintillation index of a specimen where the scintillation index was more than 0.110, and P₂ was the pitch P of the specimen where the scintillation index was more than 0.110.

As can be seen from the above, it was possible to inhibit scintillations while securing a concealing property, and to inhibit the degradation of brightness, by satisfying the formula (3).

### REFERENCE SIGNS LIST

10 image source unit
12 liquid crystal layer
13, 14 polarizing plate
15 liquid crystal panel
20 surface light source device
21 light guide plate
22 base portion
23 back face prism portion
23a unit back face prism
24 unit optical element portion
24a unit optical element
26 light source
30, 130, 230 prism sheet
31 body portion
32, 132, 232 unit prism portion
32a, 132a 232a unit prism
35, 135, 235 light diffusing layer
36 light transmitting resin layer
37 light diffusing particle

1. A prism sheet which changes directions of incident lights to emit the incident lights, the prism sheet comprising:
a body portion formed in a sheet, having a light transmitting property;
a unit prism portion arranged on one face side of the body portion, having a plurality of unit prisms each having a convex shape and arrayed in a direction along a sheet face; and
a light diffusing layer arranged on the other face side of the body portion, wherein:
a vertex angle at a tip of the convex shape of each of the unit prisms is no more than 80°; and
Ra≦−0.0296·P+1.9441 is satisfied wherein P (μm) is a pitch of the plurality of unit prisms, and Ra (μm) is a surface roughness of the light diffusing layer.

2. A prism sheet which changes directions of incident lights to emit the incident lights, the prism sheet comprising:
a body portion formed in a sheet, having a light transmitting property;
a unit prism portion arranged on one face side of the body portion, having a plurality of unit prisms each having a convex shape and arrayed in a direction along a sheet face; and
a light diffusing layer arranged on the other face side of the body portion, wherein:
one side across a tip of the convex shape is a light input face of each of the unit prisms, the other side is a reflection face, and the reflection face consists of three faces each having a different inclination angle; and
Ra≦−0.0263·P+2.0537 is satisfied wherein P (μm) is a pitch of the plurality of unit prisms and no less than 10 μm, and Ra (μm) is a surface roughness of the light diffusing layer and no less than 0.035.

3. A prism sheet which changes directions of incident lights to emit the incident lights, the prism sheet comprising:
a body portion formed in a sheet, having a light transmitting property;
a unit prism portion arranged on one face side of the body portion, having a plurality of unit prisms each having a convex shape and arrayed in a direction along a sheet face; and
a light diffusing layer arranged on the other face side of the body portion, wherein:
the unit prism is formed in a symmetrical shape and a vertex angle at a tip of the convex shape of each of the unit prisms is no more than 80°; and
Ra≦−0.0208·P+2.0223 is satisfied wherein P (μm) is a pitch of the plurality of unit prisms, and Ra (μm) is a surface roughness of the light diffusing layer.

4. A surface light source device comprising:
a light source;
a light guide plate which guides lights emitted from the light source; and
the prism sheet according to claim 1, arranged on a light output face side of the light guide plate.

5. An image source unit comprising:
the surface light source device according to claim 4; and
a liquid crystal panel arranged on a light output side of the surface light source device.

6. A liquid crystal display device comprising:
the image source unit according to claim 5; and
a housing accommodating the image source unit thereinside.

7. A surface light source device comprising:
a light source;
a light guide plate which guides lights emitted from the light source; and
the prism sheet according to claim 2, arranged on a light output face side of the light guide plate.

8. A surface light source device comprising:
a light source;
a light guide plate which guides lights emitted from the light source; and
the prism sheet according to claim 3, arranged on a light output face side of the light guide plate.
